(19) United States
(12) Patent Application Publication
(10) Pub. No.: US 2015/0070323 A1
(43) Pub. Date: Mar. 12, 2015

(54) DISPLAY-TO-DISPLAY DATA TRANSMISSION

(71) Applicant: Qualcomm Incorporated, San Diego, CA (US)

(72) Inventors: John Hyunchul Hong, San Clemente, CA (US); Paul Eric Jacobs, La Jolla, CA (US); Matthew Stuart Grob, La Jolla, CA (US)

(73) Assignee: Qualcomm Incorporated, San Diego, CA (US)

(21) Appl. No.: 14/243,399

(22) Filed: Apr. 2, 2014

Related U.S. Application Data
(63) Continuation-in-part of application No. 14/088,021, filed on Nov. 22, 2013.
(60) Provisional application No. 61/876,087, filed on Sep. 10, 2013.

(51) Int. Cl. G06F 3/147; G06F 3/042; H04L 29/08; G06F 21/32

(52) U.S. Cl. CPC G06F 3/147; G06F 21/32; G06F 3/0421; H04L 67/1078
USPC 345/175

(57) ABSTRACT

A display device may include a display, an optical touch system proximate the display and a control system. The control system may be capable of receiving input for initiating a peer-to-peer data transfer and of performing an authentication process for the peer-to-peer data transfer. The authentication process may involve obtaining fingerprint images via the optical touch system. The display device may provide a prompt to position the display device proximate a second device, e.g., with the display adjacent to a display of the second device. The display may display data transfer parameters for the peer-to-peer data transfer. The optical touch system may receive a confirmation that the second device received the data transfer parameters. The peer-to-peer data transfer may be performed, at least in part, by an array of optical transceivers.

### PRIORITY CLAIM

This application claims priority to U.S. Provisional Patent Application No. 61/876,087 (Attorney Docket No. QUALP194PUS/132295P1), filed on Sep. 10, 2013 and entitled “PHOTOCONDUCTIVE OPTICAL TOUCH,” which is hereby incorporated by reference. This application claims priority to, and is a continuation-in-part of, U.S. patent application Ser. No. 14/088,021 (Attorney Docket No. QUALP194US/132295), filed on Nov. 22, 2013 and entitled “PHOTOCONDUCTIVE OPTICAL TOUCH,” which is hereby incorporated by reference.

### TECHNICAL FIELD

This disclosure relates to data transfer and particularly relates to peer-to-peer data transfer.

### DESCRIPTION OF THE RELATED TECHNOLOGY

The ability to conveniently, securely and rapidly transfer data from a mobile device to another device could provide a very convenient way to share music, videos and other data with others. However, existing systems generally depend on the user manually managing wireless connections (e.g., Wi-Fi or Bluetooth™) to enable device-to-device transfers, which is not convenient. Moreover, many users are concerned about the confidentiality and/or integrity of their personal data. Some existing systems do not adequately address these security concerns. Improved methods and devices would be desirable.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display device which may include a display, an optical touch system proximate the display, an interface system and a control system. The control system may be capable of receiving, via the interface system, input for initiating a peer-to-peer data transfer, of performing an authentication process for the peer-to-peer data transfer and of controlling the display device to provide a prompt to position the display device proximate a second device. The control system may be capable of controlling the display to display data transfer parameters for the peer-to-peer data transfer, of receiving, via the optical touch system, a confirmation that the second device received the data transfer parameters; and of performing the peer-to-peer data transfer according to the data transfer parameters. In some implementations, the photoconductive traces and the metal traces may form at least a portion of a light-masking layer on the display substrate.

The display device of may include a memory system. The authentication process may involve providing a prompt to place at least one finger on a surface of the optical touch system, receiving, via the optical touch system, at least one fingerprint image, determining received fingerprint data corresponding to the at least one fingerprint image and comparing the received fingerprint data with stored fingerprint data in the memory system.

The optical touch system may include a plurality of substantially parallel photoconductive traces formed on a substantially transparent substrate proximate the display. The optical touch system may include a plurality of substantially parallel metal traces formed on the substantially transparent substrate. The metal traces may be substantially orthogonal to, and configured for electrical connection with, the photoconductive traces.

The optical touch system may include a plurality of Schottky diodes. In some implementations, each Schottky diode may be located at an electrical connection between a metal trace and a photoconductive trace. The Schottky diodes may include a metal contact at the electrical connection between the metal trace and the photoconductive trace. The metal contact may include palladium, platinum, chromium, tungsten, molybdenum, palladium silicide, platinum silicide and/or other metals that will induce a Schottky barrier.

In some implementations, the control system may be capable of applying a voltage to each of the photoconductive traces, in sequence. The control system may be capable of determining changes in electrical conductivity in portions of the photoconductive traces caused by changes in intensity of incident light.

In some examples, the control system may be capable of performing the peer-to-peer data transfer according to a WiFi protocol, according to a Bluetooth™ protocol or via a direct optical link. In some implementations, the photoconductive traces may include at least one of amorphous silicon, a conductive polymer, cadmium sulfide, selenium, lead sulfide or quantum dots.

Another innovative aspect of the subject matter described in this disclosure can be implemented in a display device which may include a first display, a user input system, a first array of optical transceivers disposed within an area of the first display and a control system. The control system may be capable of receiving, via the user input system, input for initiating a peer-to-peer data transfer, of controlling the display device to provide a prompt to position the display device proximate a second device, of providing data transfer parameters for the peer-to-peer data transfer to the second device and of performing the peer-to-peer data transfer via the first array of optical transceivers.

In some implementations, the area of the first display may be a border area or a display area. In some examples, the first display may be disposed on a first side of the display device. The display device also may include a second display on a second and opposing side of the display device. The control system may be capable of controlling the second display to display alignment information for aligning the first array of optical transceivers with a second array of optical transceivers of the second device.

In some implementations wherein the first display is disposed on a first side of the display device, an optical touch system may be disposed on at least a portion of the first display. The optical touch system may include a plurality of substantially parallel photoconductive traces formed on a substantially transparent substrate proximate the display. The optical touch system may include a plurality of substantially parallel metal traces formed on the substantially transparent substrate. The metal traces may be substantially orthogonal to, and configured for electrical connection with, the photoconductive traces.

In some such examples, the control system may be capable of receiving, via the optical touch system, a confirmation that the second device received the data transfer parameters. In some implementations, the control system may be capable of receiving, via the optical touch system, alignment information corresponding to a location of a second set of optical transceivers of the second device.

The control system may be capable of performing an authentication process that may involve providing a prompt to place at least one finger on a surface of the optical touch system, receiving, via the optical touch system, at least one fingerprint image, determining received fingerprint data corresponding to the at least one fingerprint image and comparing the received fingerprint data with stored fingerprint data.

In some implementations, the first array of optical transceivers may include at least a subset of sensor pixels of the optical touch system. In some examples, the first array of optical transceivers may include at least a subset of display pixels of the first display. The control system may be further capable of controlling at least one of the subset of display pixels or the subset of sensor pixels to operate in parallel.

Other innovative aspects of the subject matter described in this disclosure can be implemented in various methods. Such methods may involve receiving input for initiating a peer-to-peer data transfer, performing, via a display device, an authentication process for the peer-to-peer data transfer, providing a prompt, via the display device, to position the display device proximate a second device and controlling a display of the display device to display data transfer parameters for the peer-to-peer data transfer. The methods may involve receiving, via an optical touch system of the display device, a confirmation that the second device received the data transfer parameters and performing the peer-to-peer data transfer according to the data transfer parameters.

In some implementations, the authentication process may involve providing a prompt to place at least one finger on a surface of the optical touch system, receiving, via the optical touch system, at least one fingerprint image, determining received fingerprint data corresponding to the at least one fingerprint image and comparing the received fingerprint data with stored fingerprint data. In some examples, the peer-to-peer data transfer may be performed according to a WiFi protocol, according to a Bluetooth™ protocol or via a direct optical link.

Alternatively, or additionally, such methods may involve receiving, via a user input system of a display device, input for initiating a peer-to-peer data transfer, providing a prompt, via the display device, to position a first display of the display device proximate a second display of a second device, providing data transfer parameters for the peer-to-peer data transfer to the second device and performing the peer-to-peer data transfer via a first array of optical transceivers disposed within an area of the first display.

Such methods may involve controlling a second display, disposed on a second and opposing side of the display device, to display alignment information for aligning the first array of optical transceivers with a second array of optical transceivers of the second device.

Some such methods may involve receiving, via an optical touch system, a confirmation that the second device received the data transfer parameters. Some such methods may involve receiving, via an optical touch system, alignment information corresponding to a location of a second set of optical transceivers of the second device.

Such methods may involve an authentication process. Some such authentication processes may involve providing a prompt to place at least one finger on a surface of an optical touch system, receiving, via the optical touch system, at least one fingerprint image, determining received fingerprint data corresponding to the at least one fingerprint image and comparing the received fingerprint data with stored fingerprint data. The peer-to-peer data transfer may be performed, at least in part, by a subset of display pixels of the first display. The peer-to-peer data transfer may be performed, at least in part, by a subset of sensor pixels of an optical touch system.

The methods disclosed herein may be performed, at least in part, according to software stored in a non-transitory medium. The software may include instructions for controlling one or more devices. For example, such non-transitory media may include random-access memory (RAM), read-only memory (ROM), flash memory, optical disk storage, magnetic disk storage or other magnetic storage devices, etc.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a flow diagram that outlines blocks of a peer-to-peer data transfer method.

FIG. 2A shows an example of a visual user prompt that may be presented on a display as part of an authentication process for a peer-to-peer data transfer method.

FIG. 2B shows an example of a visual user prompt to move a display of a first display device proximate a display of a second display device.

FIG. 2C shows an example of moving a display of a first display device proximate a display of a second display device.

FIG. 3 shows an example of the first display device and the second display device of FIG. 2C positioned for a peer-to-peer data transfer.

FIG. 4 is a block diagram that shows examples of elements of a display device capable of performing a peer-to-peer data transfer.

FIG. 5 shows an example of a flow diagram that outlines blocks of an alternative peer-to-peer data transfer method.

FIGS. 6A-6C show examples of optical transceiver arrays positioned in various areas of a display device.

FIG. 6D shows an example of visual alignment information that may be used to facilitate a peer-to-peer data transfer method.

FIG. 7 is a block diagram that shows examples of elements of a display device capable of performing various peer-to-peer data transfer methods.

FIG. 8 shows an example of a flow diagram that outlines blocks of a method of switching a display device between a display operational mode and a peer-to-peer data transfer mode.

FIG. 9 is a block diagram that shows examples of elements of an optical touch sensing device.

FIG. 10 is a perspective diagram that shows examples of elements of an optical sensing device in a first mode of operation.

FIG. 11 is a schematic diagram that shows examples of elements of the optical touch sensing device of FIG. 2 in a second mode of operation.

FIG. 12 shows an example of a flow diagram that outlines blocks of an optical touch sensing method.

FIG. 13 shows a top view of examples of elements of an alternative optical touch sensing device.

FIG. 14 shows a cross section of examples of elements of an optical touch sensing device in a fingerprint sensing mode of operation.

FIG. 15 shows an image of a fingerprint detected by an optical touch sensing device like that of FIG. 5.

FIG. 16 is a flow diagram that outlines a method of operating an optical touch sensing device.

FIG. 17 shows an example of an isometric view depicting two adjacent pixels in a series of pixels of an interferometric modulator (IMOD) display device.

FIG. 18 shows an example of a system block diagram illustrating an electronic device incorporating a 3×3 IMOD display.

FIGS. 19A and 19B show examples of system block diagrams illustrating a display device that include a touch sensor as described herein.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be capable of displaying an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, a display device may include a display, an optical touch system proximate the display and a control system. The control system may be capable of receiving input for initiating a peer-to-peer data transfer and of performing an authentication process for the peer-to-peer data transfer. The authentication process may, for example, involve obtaining fingerprint images via the optical touch system.

The control system may be capable of controlling the display device to provide a prompt to position the display device proximate a second device. For example, the display device may provide visual and/or audio prompts to place the display adjacent to a display of the second device. The control system may be capable of controlling the display to display data transfer parameters for the peer-to-peer data transfer, of receiving, via the optical touch system, a confirmation that the second device received the data transfer parameters and of performing the peer-to-peer data transfer according to the data transfer parameters.

In some implementations, the peer-to-peer data transfer may be performed, at least in part, by an array of optical transceivers. The array of optical transceivers may, for example, be disposed within a display area, e.g., in a display border area. In some implementations, the first array of optical transceivers may include at least a subset of sensor pixels of the optical touch system and/or a subset of display pixels.

Particular implementations of the subject matter described in this disclosure can be implemented to realize one or more of the following potential advantages. Some implementations provide methods and devices for fast, secure and convenient peer-to-peer data transfer. Some implementations may provide an optical touch sensing device with higher sensitivity, higher resolution, robustness and better energy efficiency than prior art touch sensing devices. Some such optical touch sensing devices may be capable of functioning as fingerprint sensors and/or cameras. In some implementations, an authentication process may be based, at least in part, on fingerprint data obtained by such a fingerprint sensor. Some optical touch sensors can be incorporated into black matrix traces of a display, which can provide high resolution without introducing optical artifacts or otherwise degrading the display quality.

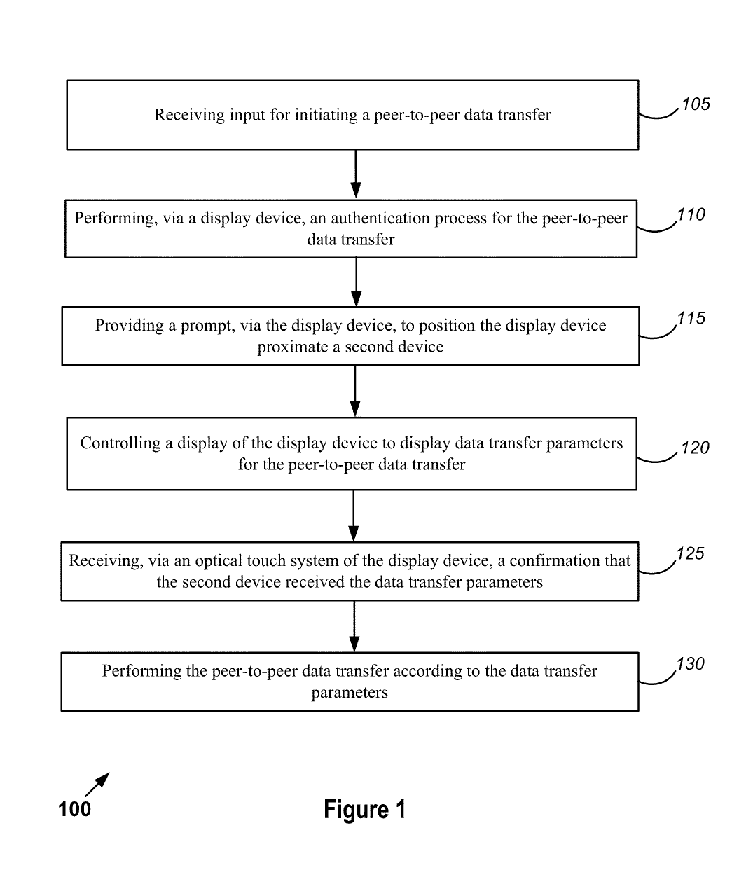

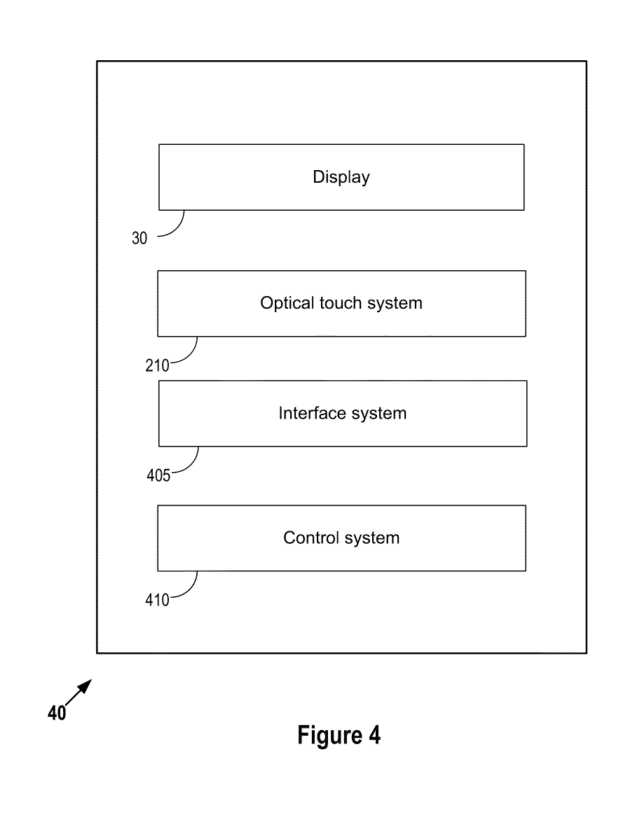

FIG. 1 shows an example of a flow diagram that outlines blocks of an optical touch sensing method. Method 100 may be performed, at least in part, by one or more elements of a control system, such as the control system 415 shown in FIG. 4. The control system may be part of a display device. As with other methods described herein, the operations of method 100 are not necessarily performed in the order indicated. Moreover, method 100 may involve more or fewer blocks than are shown in FIG. 1.

In this example, method 100 begins with block 105, which involves receiving input for initiating a peer-to-peer data transfer. Such input may, for example, be user input received via a user input system of a display device. Such input may be based on voice commands received via a microphone, input received via a graphical user interface (GUI) presented on a display, e.g., via a touch system, etc. In some implementations, the input of block 105 may be received via an optical touch system, such as the optical touch system 410 shown in FIG. 4 and described below.

Here, block 110 involves performing, via a display device, an authentication process for the peer-to-peer data transfer. The authentication process may involve processing one or more types of authentication data, such as data received via a user interface (e.g., an alphanumeric password, personal information, etc.) and/or biometric information received from one or more biometric devices.

In some implementations, block 110 may involve obtaining fingerprint data. As used herein, the term “fingerprint” may refer to a fingerprint or a thumbprint. As used herein, “fingerprint data” may include various types of data known by those of skill in the various fields of fingerprint identification or “dactyloscopy,” including but not limited to finger or thumb friction ridge image data and data used to characterize fingerprint minutiae, such as data corresponding to the types, locations and/or spacing of fingerprint minutiae. Fingerprint data may, for example, be based on one or more fingerprint images.

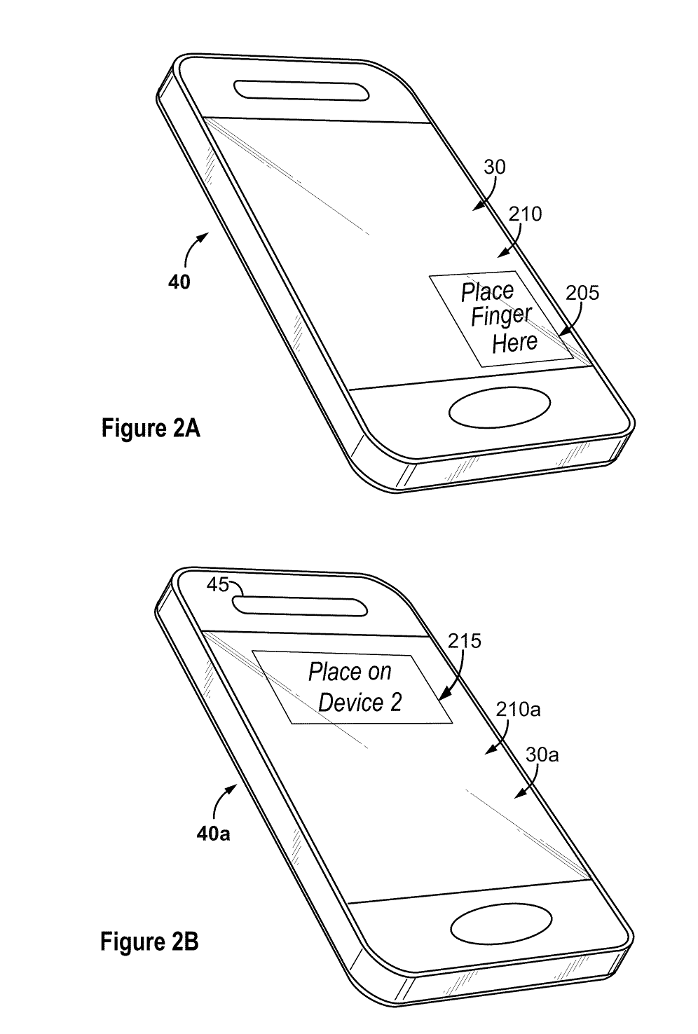

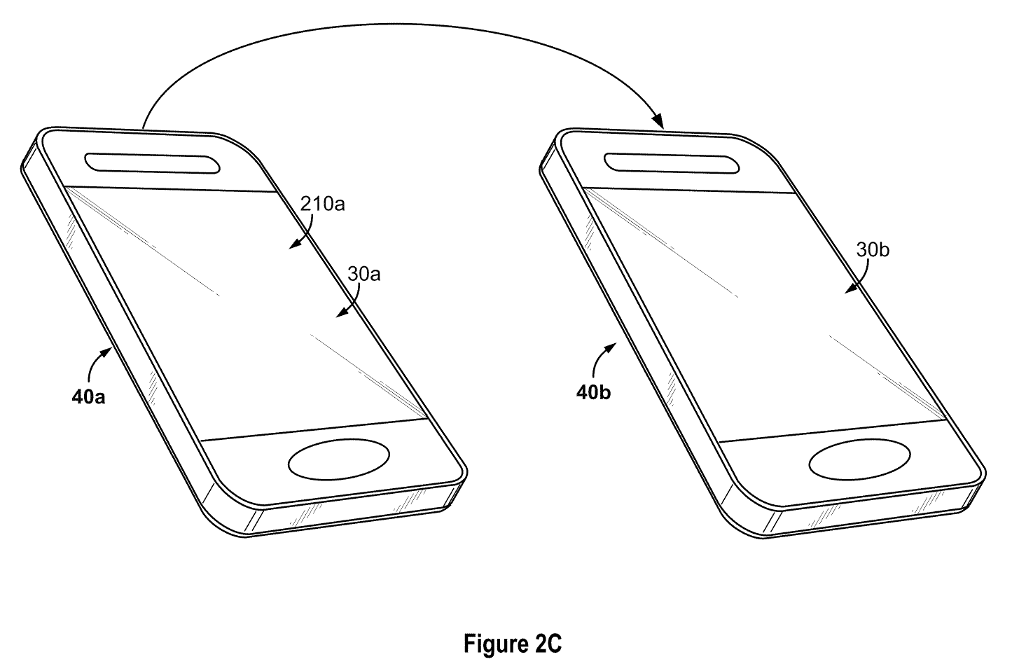

FIG. 2A shows an example of a visual user prompt that may be presented on a display as part of an authentication process for a peer-to-peer data transfer method. In some implementations, a visual user prompt such as that shown in FIG. 2A may be presented if block 110 involves obtaining one or more fingerprint images. Alternatively, or additionally, an audio and/or tactile prompt may be provided. In this example, block 110 involves prompting a user to place at least one finger in an area 205 of a display 30 of the display device 40. The area 205 may, for example, coincide with an area in which a fingerprint sensor is located. The fingerprint sensor may be an optical sensor, an ultrasonic sensor, a capacitive sensor, etc., depending on the particular implementation. The fingerprint sensor may or may not be disposed in the same area as the display 30. For example, in some implementations an ultrasonic fingerprint sensor may be located in a border area near the edge of the display 30.

In this example, an optical touch system 210, disposed on the display 30, is capable of acquiring fingerprint images. Accordingly, in this example block 110 of FIG. 1 involves receiving, via the optical touch system, at least one fingerprint image. Block 110 may involve determining received fingerprint data (such as data corresponding to the types, locations and/or spacing of fingerprint minutiae) corresponding to the at least one fingerprint image and comparing the received fingerprint data with stored fingerprint data.

For example, block 110 may involve comparing the fingerprint data with master fingerprint data of a rightful user of a display device and determining, based at least in part on the comparing process, whether to authorize the peer-to-peer data transfer. For example, the master fingerprint data may be stored in a memory of (or a memory accessible by) the display device. In some examples, the master fingerprint data may be accessible by the display device via a data network, e.g., from a server via the Internet. The master fingerprint data may have been obtained from the rightful user during a prior data-gathering process, such as an enrollment process.

In this example, the authentication process of block 110 is successful and the method 100 continues to block 115. Here, block 115 involves providing a prompt to position the display device proximate a second device. In this implementation, block 115 involves providing the prompt via the display device. The prompt may, for example, be an audio, visual and/or tactile prompt.

FIG. 2B shows an example of a visual user prompt to move a display of a first display device proximate a display of a second display device. In this example, block 115 of FIG. 1 involves controlling the display 30a to provide a visual user prompt in an area 215. In this example, a visual user prompt is encouraging a user to place the display device 40a on another device. Alternatively, or additionally, one or more audio prompts may be made via the speaker 45. In this example, block 115 involves providing a prompt to position the display device proximate another display device.

FIG. 2C shows an example of moving a display of a first display device proximate a display of a second display device. In this example, the display device 40a is in the process of being positioned for a peer-to-peer data transfer with the display device 40b, which is substantially the same as the display device 40a.

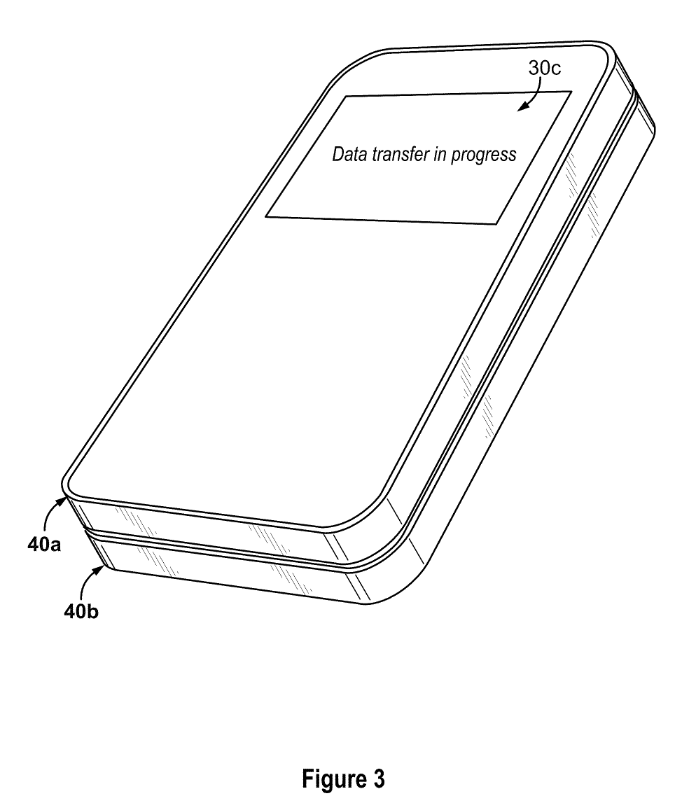

FIG. 3 shows an example of the first display device and the second display device of FIG. 2C positioned for a peer-to-peer data transfer. In the example shown in FIG. 3, the display device 40a is lying on top of the display device 40b, with the display 30a of the display device 40a proximate to, and aligned with, the display 30b of the display device 40b. The displays 30a and 30b are shown in FIG. 2C, but are hidden in FIG. 3.

As used herein, terms such as “front,” “back,” “top,” “bottom,” “upper” and “lower” are sometimes used for ease of describing the figures, to indicate relative positions corresponding to the orientation of the figure on a properly oriented page, and may not reflect the proper orientation of a device as implemented. In this case, the display device 40a includes a secondary display 30c that is disposed on a second and opposing side of the display device 40a, relative to the display 30a, and this side is referred to as the “back” for the sake of convenience. In some implementations, the secondary display 30c may be an interferometric modulator (IMOD) display. However, in other implementations the secondary display 30c may be a liquid crystal display (LCD) or another type of display. In this example, the secondary display 30c is indicating that a peer-to-peer data transfer is in progress between the display device 40a and the display device 40b. Some other uses of the secondary display 30c in the context of peer-to-peer data transfers are described below.

Referring again to FIG. 1, in this example block 120 involves controlling a display of the display device to display data transfer parameters for the peer-to-peer data transfer. In this example, the display 30a of the display device 40a may display data transfer parameters indicating that a peer-to-peer data transfer will be performed according to a particular data protocol, such as a WiFi protocol, a Bluetooth™ protocol, or a via a protocol appropriate for a direct optical link. The display data transfer parameters may be displayed according to any appropriate format, such as via an alphanumeric code, a bar code (such as a 2-D bar code), etc. In alternative implementations, the data transfer parameters may be provided in another form, e.g., according to an audio code.

In various implementations, the display device 40b is capable of receiving data transfer parameters for initiating the peer-to-peer data transfer. In this example, the display device 40b includes an optical touch system capable of reading the data transfer parameters for the peer-to-peer data transfer from the display 30a of the display device 40a. In some implementations, the display device 40b may be adapted to provide a confirmation (e.g., by displaying the confirmation on the display 30b) that the display device 40b received the data transfer parameters. In some implementations, the confirmation may be part of a “handshake” process, such as a Wi-Fi or Bluetooth handshake process.

Accordingly, in this implementation, block 125 involves receiving, via an optical touch system of the display device, a confirmation that the second device received the data transfer parameters. In this example, block 125 involves receiving, via the optical touch system 210a of the display device 40a, a confirmation that the display device 40b received the data transfer parameters provided in block 120.

Block 130 involves performing the peer-to-peer data transfer according to the data transfer parameters. As noted above, the peer-to-peer data transfer may be performed according to a variety of protocols, including but not limited to a WiFi protocol, a Bluetooth™ protocol, or a via a protocol appropriate for a direct optical link.

FIG. 4 is a block diagram that shows examples of elements of a display device capable of performing a peer-to-peer data transfer. In this example, the display device 40 includes a display 30, an optical touch system 210, an interface system 405 and a control system 410. The display 30 may be substantially as described elsewhere herein.

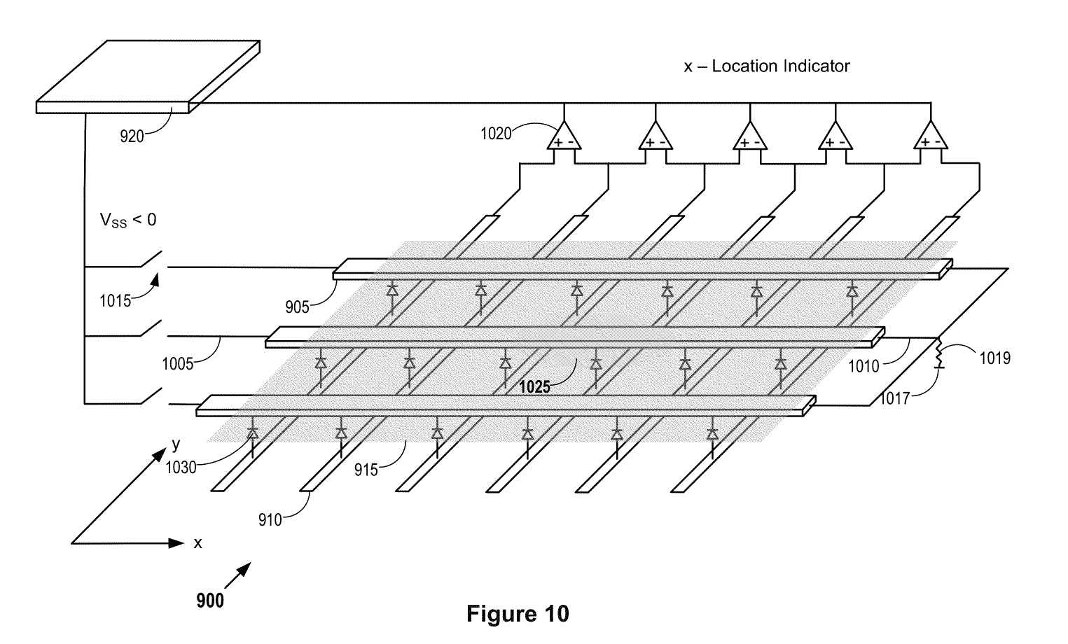

Various examples of the optical touch system 210 are provided below, e.g., with reference to FIGS. 10-14. In some implementations, the optical touch system 210 may include a plurality of substantially parallel photoconductive traces formed on a substantially transparent substrate proximate the display 30. The photoconductive traces may be formed of amorphous silicon, a conductive polymer, cadmium sulfide, selenium, lead sulfide and/or quantum dots. The optical touch system 210 may include a plurality of substantially parallel metal traces formed on the substantially transparent substrate. The metal traces may be substantially orthogonal to, and configured for electrical connection with, the photoconductive traces. The control system 410 may be capable of applying a voltage to each of the photoconductive traces, in sequence, and of determining changes in electrical conductivity in portions of the photoconductive traces caused by changes in intensity of incident light.

The optical touch system 210 may include a plurality of Schottky diodes. Each Schottky diode may be located at an electrical connection between a metal trace and a photoconductive trace. Each Schottky diode may include a metal contact at the electrical connection between the metal trace and the photoconductive trace. The metal contact may include at least one of palladium, platinum, chromium, tungsten, molybdenum, palladium silicide, platinum silicide or other metals that will induce a Schottky barrier.

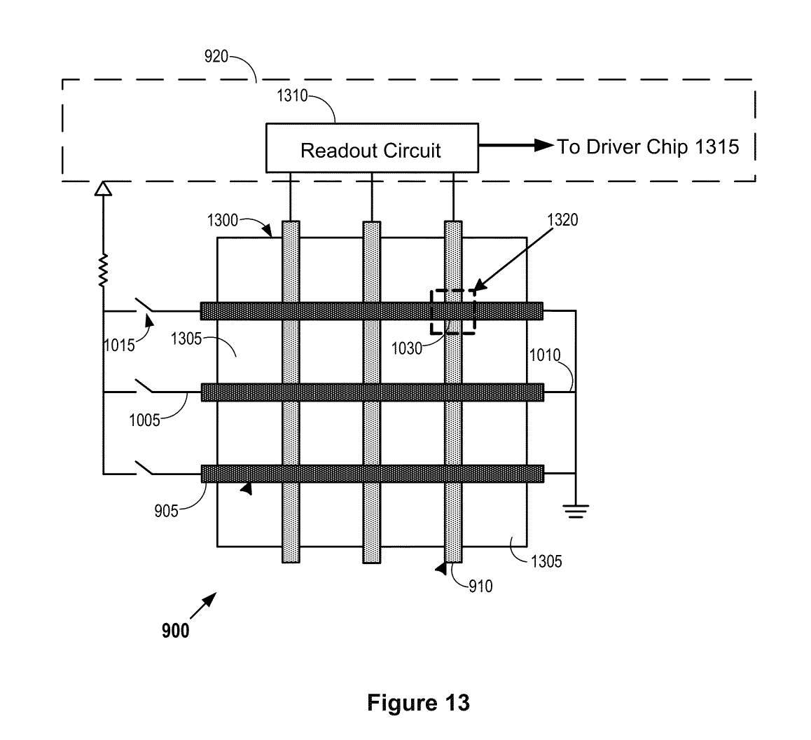

In some implementations, such as that as shown in FIG. 13 and described below, the photoconductive traces and the metal traces may form at least a portion of a light-masking layer on the display substrate. In some such implementations, a sensor pixel of the optical touch system 210 may correspond with a single pixel of the display 30. In some such implementations, a pixel of one display may be used as a transmitter and a sensor pixel of an optical touch system 210 of a second display device 40 may be used as a receiver during a peer-to-peer data transfer.

The interface system 405 may, for example, include one or more network interfaces, user interfaces, etc. The interface system 405 may include one or more universal serial bus (USB) interfaces or similar interfaces. The interface system 205 may include wireless or wired interfaces.

The control system 410 may include one or more processors, such as one or more general purpose single- or multi-chip processors, digital signal processors (DSPs), application specific integrated circuits (ASICs), field programmable gate arrays (FPGAs) or other programmable logic devices, discrete gate or transistor logic, discrete hardware components, or combinations thereof. The control system 410 may be capable of performing the methods described herein, at least in part.

For example, the control system 410 may be capable of receiving input, via the interface system 405, for initiating a peer-to-peer data transfer. The control system 410 may be capable of performing an authentication process for the peer-to-peer data transfer. The authentication process may involve controlling the display device 40 to provide an audio and/or visual prompt to place at least one finger on a surface of the display device 40. In some implementations, the prompt may be to place at least one finger on a surface of the display 30.

In this example, the optical touch system 210 is disposed on at least a portion of the display 30 and the prompt indicates that a user should place at least one finger on a surface of the optical touch system 210.

The authentication process may involve receiving at least one fingerprint image. Fingerprint images may be received via the optical touch system 210 or via another type of fingerprint sensor, e.g., an ultrasonic fingerprint sensor, a capacitive fingerprint sensor, etc.

The control system 410 may be capable of determining received fingerprint data corresponding to the received fingerprint image(s). As noted elsewhere herein, “fingerprint data” as used herein includes data that may be used to characterize fingerprint minutiae, such as data corresponding to the types, locations and/or spacing of fingerprint minutiae.

The control system 410 may be capable of comparing the received fingerprint data with stored fingerprint data as part of the authentication process. In some implementations, the stored fingerprint data may be stored in a memory system of the display device 40. The memory system may include one or more non-transitory media, such as random access memory (RAM) and/or read-only memory (ROM). The memory system may include one or more other suitable types of non-transitory storage media, such as flash memory, one or more hard drives, etc. In some implementations, the interface system 405 may include at least one interface between the control system 410 and the memory system. However, in some implementations the authentication process may involve retrieving stored fingerprint data from another device via the interface system 405. For example, the stored fingerprint data may reside on a server accessible via the Internet.

The control system 410 may be capable of controlling the display device 40 to provide a prompt to position the display device 40 proximate a second device. For example, the control system 410 may be capable of controlling the display device 40 to provide visual and/or audio prompts to place the display 30 adjacent to a display of another display device. The control system 410 may be capable of controlling the display 30 to display data transfer parameters for the peer-to-peer data transfer and of receiving, via the optical touch system 210, a confirmation that the second device received the data transfer parameters.

The control system 410 may be capable of performing the peer-to-peer data transfer according to the data transfer parameters. In some examples, the control system 410 may be capable of controlling a wireless interface of the interface system 405 to perform the functions of the display device 40 during a peer-to-peer data transfer. In other implementations, the control system 410 may be capable of controlling an array of optical transmitters, receivers or transceivers of the display device 40 during a peer-to-peer data transfer. In some such implementations, a pixel of one display 30 may be used as a transmitter and a sensor pixel of an optical touch system 210 of a second display device 40 may be used as a receiver during a peer-to-peer data transfer.

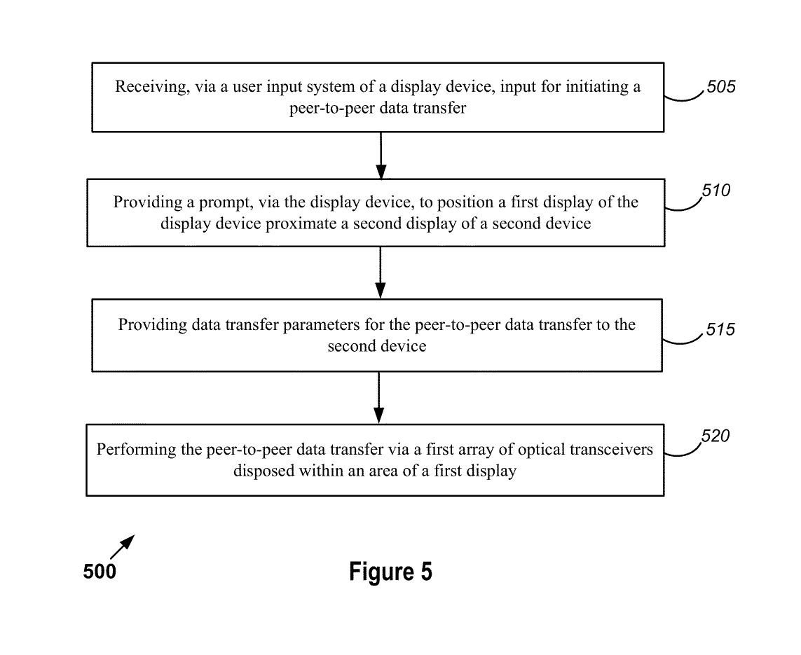

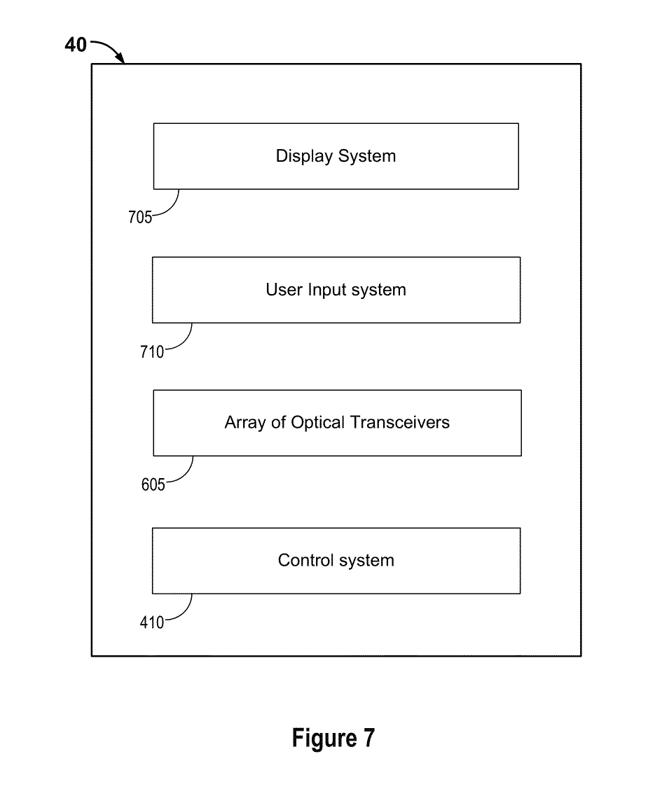

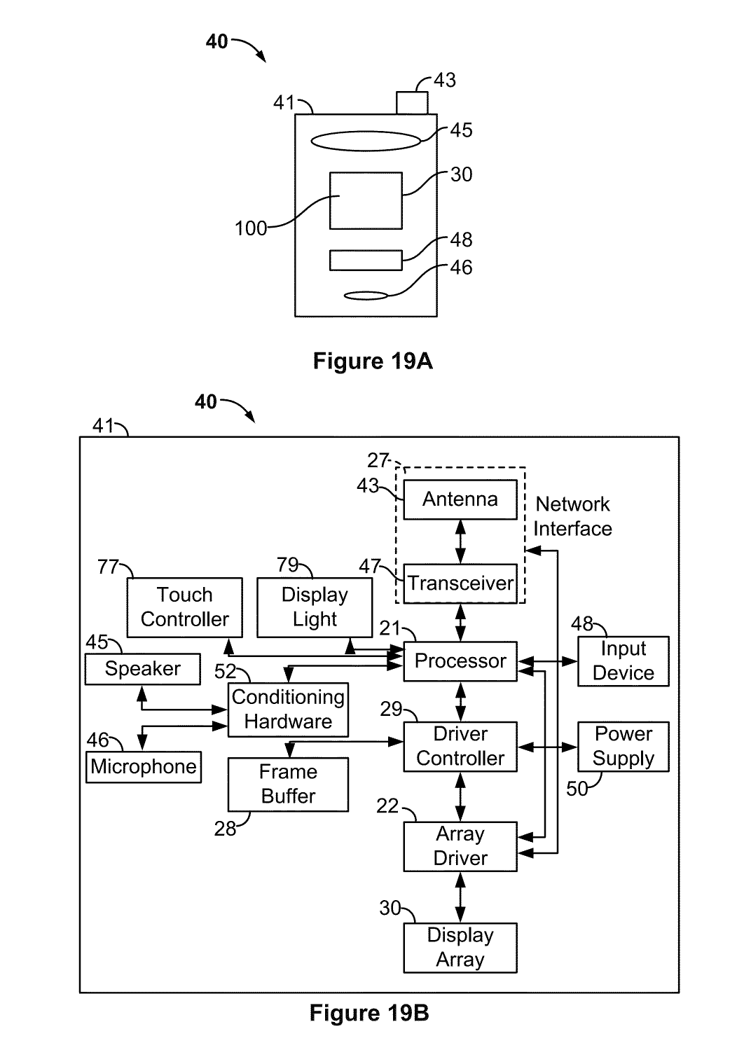

FIG. 5 shows an example of a flow diagram that outlines blocks of an alternative peer-to-peer data transfer method. In this example, method 500 begins with block 505, which involves receiving, via a user input system of a display device, input for initiating a peer-to-peer data transfer. Examples of suitable user input systems are described below with reference to FIGS. 7, 19A and 19B.

In this implementation, block 510 involves providing a prompt, via the display device, to position a first display of the display device proximate a second display of a second device. Here, block 515 involves providing data transfer parameters for the peer-to-peer data transfer to the second device. Blocks 510 and 515 may include providing user prompts and data transfer parameters such as those described above. However, block 515 does not necessarily involve providing data transfer parameters via a display. For example, block 515 may involve providing data transfer parameters via a wireless interface, via a series of audio tones, etc.

Accordingly, method 500 may or may not involve receiving confirmation, via an optical touch system, that the second device received the data transfer parameters. If method 500 does involve devices having an optical touch system, however, method 500 may include an authentication process that involves providing a prompt to place at least one finger on a surface of the optical touch system and receiving, via the optical touch system, at least one fingerprint image. The method may involve determining received fingerprint data corresponding to the at least one fingerprint image and comparing the received fingerprint data with stored fingerprint data.

Moreover, in this example block 520 involves performing the peer-to-peer data transfer via a first array of optical transceivers disposed within an area of a first display. The arrays of optical transceivers may, for example, include vertical cavity surface-emitting laser (VCSEL) devices, photodiodes and/or other devices. Such devices can be made small enough to include within a display array and may be capable of transmitting data at high rates. For example, a single 850 nm VCSEL having a radius of approximately one micron may be capable of transmitting data at a rate of 40 Gb/s. Suitable photodiodes may be somewhat larger, e.g., in the 50-100 micron range. A single 40 Gb/s link could fill up 40Mbits of memory, not counting overhead, in a 1 msec burst. Accordingly, in some implementations the display devices 40 may include a relatively large-capacity memory system (e.g., with a buffer capacity in the range of 100-1000 Mbytes) in order to send and receive large volumes of data. In alternative implementations, a pixel of one display may be used as a transmitter and a sensor pixel of an optical touch system of a second display device may be used as a receiver during a peer-to-peer data transfer.

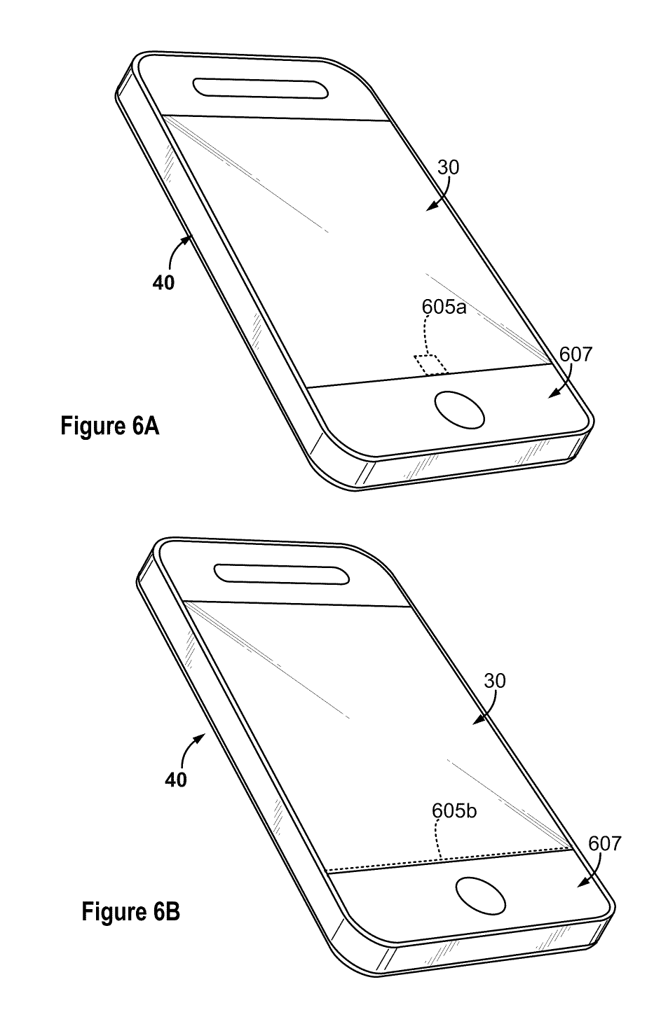

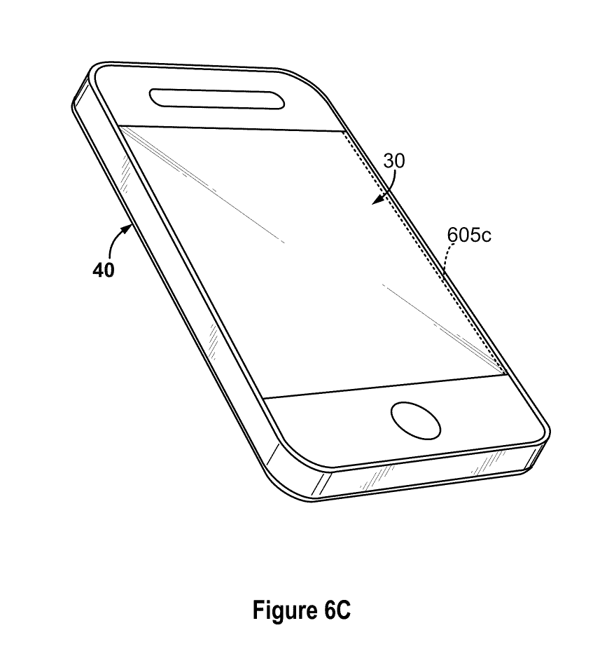

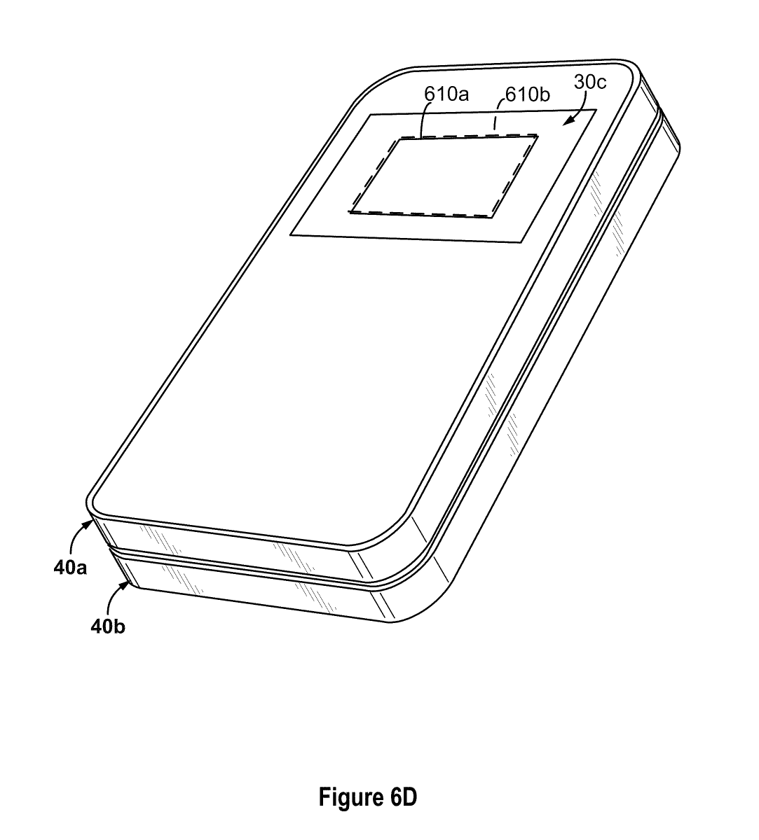

FIGS. 6A-6C show examples of optical transceiver arrays positioned in various areas of a display device. In the example shown in FIG. 6A, the optical transceiver array 605a is substantially square and is positioned at the bottom center of the display 30. Although the optical transceiver array 605a may provide effective peer-to-peer data transfer functionality, if conventional optical transceivers are formed into an array of the size and position of the optical transceiver array 605a, the array may interfere with images provided by pixels of the display 30 in this area. Depending on the form factor of the optical transceivers, there may be space for few display pixels, or no display pixels, within the area of the optical transceiver array 605a.

Accordingly, it may be desirable to form the optical transceiver array in a different size, aspect ratio and/or position. In FIG. 6B, for example, the optical transceiver array 605b has a rectangular shape, having a width that is much smaller than its length. In this example, the optical transceiver array 605b has a width that corresponds to a small number of display pixels, in order to reduce the potential interference with images presented on the display 30. In some examples, the width of the optical transceiver array 605b may correspond with fewer than 5 display pixels, 5-10 display pixels, 10-20 display pixels, etc. In this implementation, the optical transceiver array 605b extends across the bottom of the display 30, such that the length of the optical transceiver array 605b substantially corresponds with the width of the display 30. However, the optical transceiver array 605b may have a different length and/or width than shown or described herein.

Similarly, the optical transceiver array 605c shown in FIG. 6C also has a width that corresponds to a small number of display pixels. The width of the optical transceiver array 605c may correspond with fewer than 5 display pixels, 5-10 display pixels, 10-20 display pixels, etc. In this implementation, the optical transceiver array 605c extends across a side of the display 30, such that the length of the optical transceiver array 605c substantially corresponds with the length or height of the display 30. However, the optical transceiver array 605c may have a different length and/or width.

As noted elsewhere herein, in some implementations a pixel of one display device 40 may be used as a transmitter and a sensor pixel of an optical touch system of a second display device 40 may be used as a receiver during a peer-to-peer data transfer. Accordingly, in some such implementations, an array of optical transceivers may include at least a subset of sensor pixels of an optical touch system. In such implementations, the array of optical transceivers may include at least a subset of display pixels of a display. The control system may be capable of controlling the subset of display pixels and/or the subset of sensor pixels to operate in parallel. Having the optical transceiver array 605 arranged in a manner similar to that shown in FIG. 6B or 6C may facilitate such implementations, because only a small number of display pixel and sensor pixel rows or columns would need to be configured in parallel. In some implementations, only a single row or column of display pixels and sensor pixels is configured in parallel. In some such implementations, streams of data may be sent from transmitters to receivers without an accompanying clock signal. Accordingly, the control system 410 may be capable of providing clock and data recovery (CDR) functionality. Implementations such as those shown in FIG. 6A and FIG. 6B have the potential advantage of locating the optical transceiver array 605 adjacent to the bottom or “ledge” area 607, which can provide space for additional hardware related to the optical transceiver functionality, such as clock recovery circuits, controlled impedance line traces to facilitate high-bandwidth signaling, etc.

Particularly because the array of optical transceivers may occupy only a small area, it may be advantageous to provide user prompts for properly aligning display devices for a peer-to-peer data transfer. Therefore, some implementations of method 500 may involve receiving, via an optical touch system or otherwise, alignment information corresponding to the location of optical transceiver arrays that will be involved in a peer-to-peer data transfer.

FIG. 6D shows an example of visual alignment information that may be used to facilitate a peer-to-peer data transfer method. In this example, display device 40a has been placed on display device 40a. Here, the display device 40a includes a second display 30c that is disposed on a second and opposing side of the display device 40a, relative to the display 30a, which may be referred to as the “back” for the sake of convenience. The secondary display 30c may be an IMOD display, an LCD or another type of display.

In this example, the second display 30c is displaying alignment information for aligning an array of optical transceivers of display device 40a with another array of optical transceivers of display device 40b. In this example, the alignment information 610a corresponds with a location of an array of optical transceivers of display device 40a and the alignment information 610b corresponds with a location of an array of optical transceivers of display device 40b. The position and shape of the alignment information 610a and 610b does not necessarily correspond that of the actual arrays of optical transceivers. Instead, the alignment information 610a and 610b may be configured to more readily allow a user to align the arrays of optical transceivers. In some implementations, the alignment information may include crosses, other shapes of polygons (such as triangles), etc.

Other types of alignment information, such as audio prompts, may also be provided to a user. For example, a series of audio prompts may be given, advising the user how to move the display device 40a in order to more precisely align the arrays of optical transceivers. The audio prompts and/or visual prompts may indicate when the arrays of optical transceivers have been satisfactorily aligned.

FIG. 7 is a block diagram that shows examples of elements of a display device capable of performing various peer-to-peer data transfer methods. The implementation of display device 40 shown in FIG. 7 may, for example, be suitable for performing methods such as those described above with reference to FIGS. 5-6D and/or other methods described herein. Accordingly, the control system 410 may be capable of controlling the display device 40 to perform method 500 and/or other such methods. The array of optical transceivers 605 may be substantially as described elsewhere herein. The display system 705 may, in some implementations, include a main display on one side of the display device 40 and a second display on the back of the display device 40.

The user input system 710 may, for example, include apparatus such as the input device 48 described below with reference to FIGS. 19A and 19B. Accordingly, the user input system may include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 shown in FIGS. 19A and 19B may be capable of functioning as an input device for the display device 40. In some implementations, voice commands through the microphone 46 can be used for controlling operations of the display device 40.

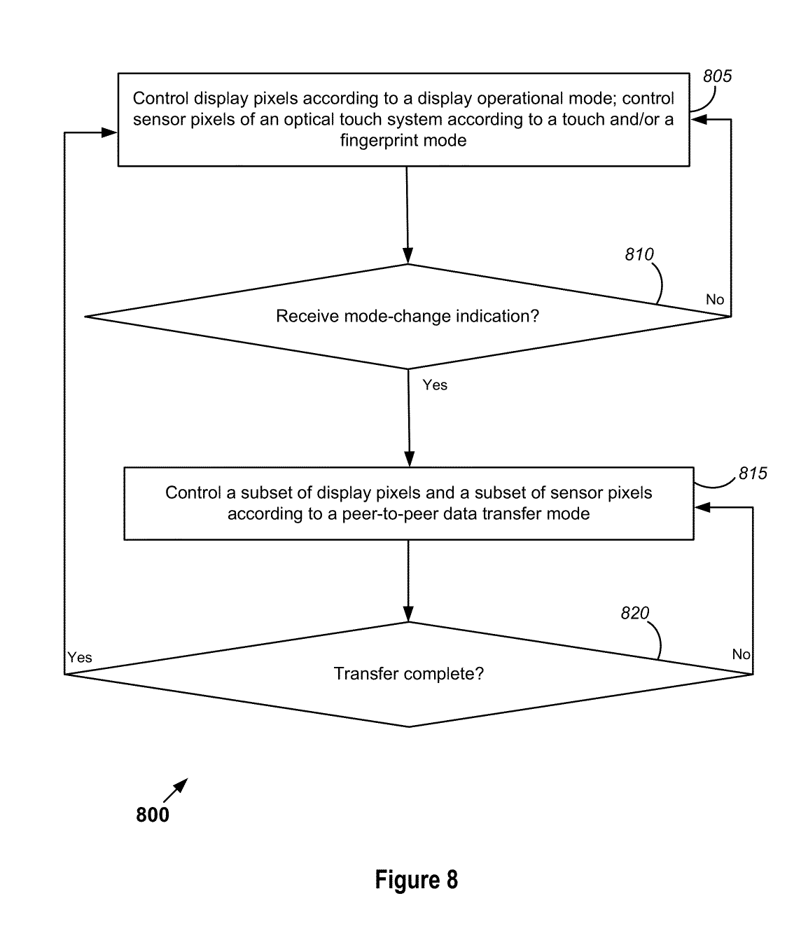

FIG. 8 shows an example of a flow diagram that outlines blocks of a method of switching a display device between a display operational mode and a peer-to-peer data transfer mode. Method 800 may be particularly applicable for those implementations in which an array of optical transceivers used for the peer-to-peer data transfer includes at least a subset of sensor pixels of an optical touch system and at least a subset of display pixels of a display.

In this example, block 805 involves controlling display pixels according to a display operational mode and controlling sensor pixels of an optical touch system according to a touch and/or a fingerprint mode. The operational modes of block 805 may correspond to a normal operational mode of a display device having an optical touch system.

Here, block 810 involves determining whether a mode-change indication is received. The mode-change indication may, for example, be received by a user input system such as described above with reference to FIG. 7. In this example, the mode-change indication is an indication to switch to a peer-to-peer data transfer mode. If it is determined in block 810 that no mode-change indication is received, the process reverts to block 805 and the display device continues in a normal operational mode. However, if it is determined in block 810 that the mode-change indication is received, the process continues to block 815.

In this example, block 815 involves controlling a subset of display pixels and a subset of sensor pixels according to the peer-to-peer data transfer mode. Block 815 may involve other processes relating to the peer-to-peer data transfer, such as those described elsewhere herein.

In block 820, it is determined whether the peer-to-peer data transfer is complete. If so, the process reverts to block 805 and the display device resumes the normal operational mode.

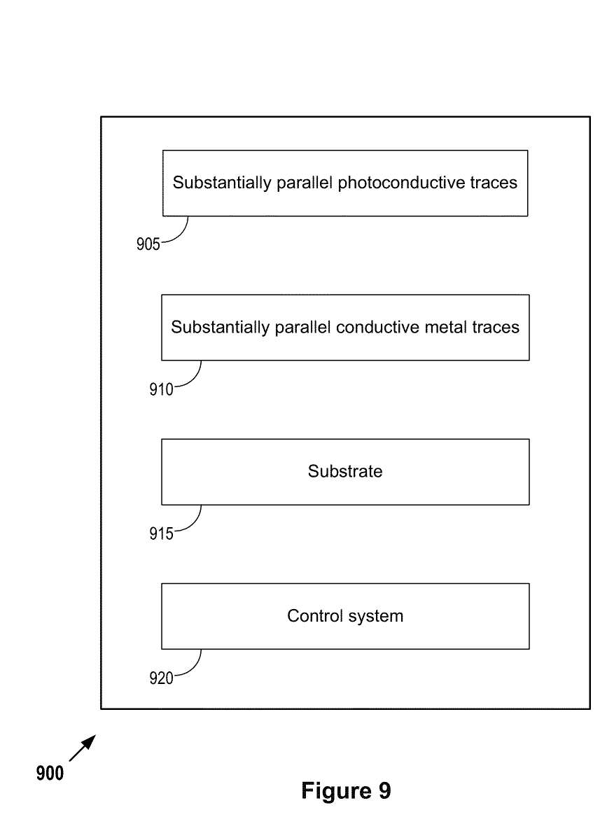

FIG. 9 is a block diagram that shows examples of elements of an optical touch sensing device. In this example, the optical touch sensing device 900 includes substantially parallel photoconductive traces 905 and substantially parallel metal traces 910, which are conductive. Here, the photoconductive traces 905 include semiconductor material. In this example, the metal traces 910 are substantially orthogonal to, and configured for forming a Schottky contact at, each overlap area between the semiconductor photoconductive traces 905 and the metal traces 910. In this implementation, both the photoconductive traces 905 and the metal traces 910 are formed on the substrate 915, except where the substantially parallel photoconductive traces 905 and the substantially parallel metal traces 910 overlap. Here, the substrate 915 is substantially transparent.

In the example shown in FIG. 9, the optical touch sensing device 900 includes a control system 920. In this implementation, the control system 920 is capable of applying a voltage to each of the photoconductive traces, in sequence, of determining changes in electrical conductivity in portions of the photoconductive traces 905 caused by changes in intensity of incident light in an area and of determining a location of the area.

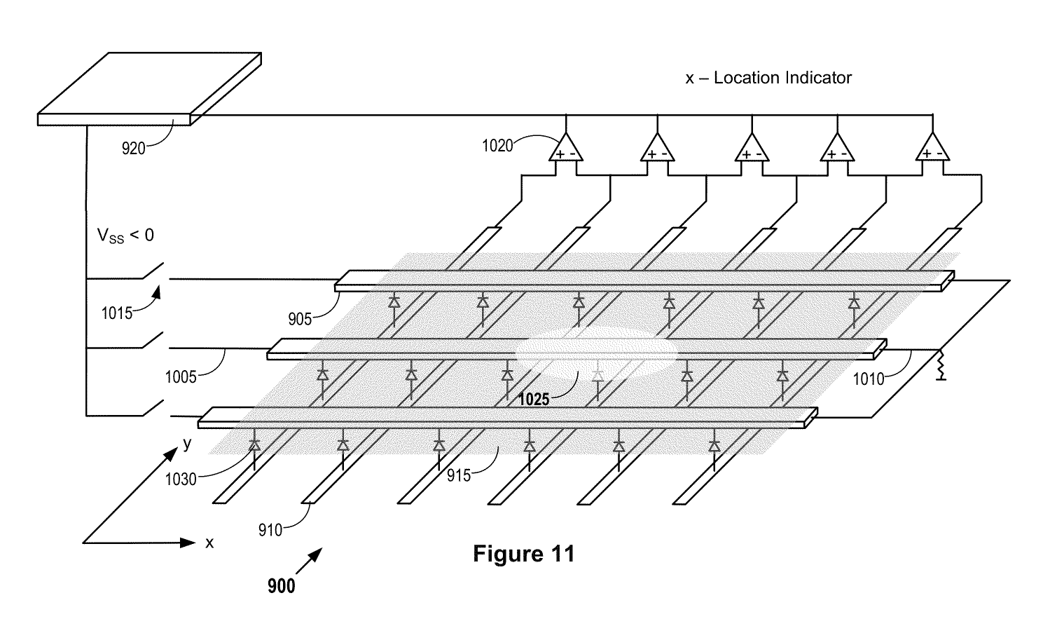

Examples of the elements of the optical touch sensing device 900 are described below with reference to FIGS. 10-12. FIG. 10 is a perspective diagram that shows examples of elements of an optical touch sensing device in a first mode of operation. In this example, the optical touch sensing device 900 is being illuminated with ambient light and no display light is in operation. In some such implementations, the control system may be capable of providing a first operational mode for use under ambient light conditions when a display light is not in operation and a second operational mode for use when a display light is in operation, such as described below with reference to FIG. 11.

In the example shown in FIG. 10, the photoconductive traces 905 are substantially parallel with one another. The metal traces 910 are also substantially parallel with one another. Here, the metal traces 910 are substantially orthogonal to, and configured for electrical connection with, the photoconductive traces 905. In order to isolate the photoconductive traces, in this example the electrical contact between the photoconductive traces 905 and the metal traces 910 is through a diode that is biased such that there is substantially no current when the switch 1015 is off. The diode, which may be a Schottky diode, is formed at the metal-semiconductor junction.

When the optical touch sensing device 900 is functioning according to a first mode of operation, a light-obstructing object, such as a finger, a hand, a stylus, etc., can locally create one or more shadows that can affect how charge is distributed within each of the photoconductive traces 905. One such shadow is formed in the area 1025. Such shadows may be caused by an object coming in contact with the optical touch sensing device 900, e.g., by a finger touching the optical touch sensing device 900. Alternatively, or additionally, such shadows may be caused by an object coming near to, but not in physical contact with, the optical touch sensing device 900. By detecting changes in charge distribution caused by such shadows, the control system 920 may be capable of detecting touch and/or gestures via the optical touch sensing device 900.

In this implementation, the control system 920 is capable of causing each of the photoconductive traces 905 to be biased by a static voltage, with one end of the trace (here, the biased end 1005) at a positive or negative voltage and the opposite end of the trace (here, the grounded end 1010) grounded. In some implementations, the end of traces 1005 and 1010 may be more heavily doped to form a better ohmic contact. In this example, the photoconductive traces 905 are connected to an array of switches 1015 on the biased end 1005 and a common ground 1017 with a pull-down resistor 1019 on the grounded end 1010.

In this example, the photoconductive traces 905 include amorphous silicon (a-Si). In alternative implementations, the photoconductive traces 905 may include one or more materials such as gallium arsenide, germanium, or indium phosphide, that are photoconductive and are able to form a Schottky diode when in contact with certain metals. Here, the photoconductive traces 905 are formed into substantially parallel wires, substantially along the “x” axis, on the substrate 915. In some implementations, the photoconductive traces 905 and the metal traces 910 may have widths in the range of 1-30 microns and may have thicknesses in the range of 100 Angstroms to 1 micron. The conductive metal material of the metal traces 910 may be chosen such that it forms a high Schottky barrier to minimize leakage current. The metal materials may include platinum, chromium, molybdenum, or tungsten, and certain silicides, e.g., palladium silicide and platinum silicide. Although three photoconductive traces 905 and six metal traces 910 are shown in FIG. 10, the optical touch sensing device 900 will generally include more of each type of trace. For example, in some implementations, the optical touch sensing device 900 may include hundreds, thousands or tens of thousands of each type of trace.

However, some implementations may include more or fewer traces. Some implementations, for example, may include only a single photoconductive trace 905. The photoconductive trace simply detects the presence of light somewhere on the panel. In order to image an object such as a finger or a fingerprint, the display pixels are activated in sequence, following a raster scan, in which an individual pixel is turned on and then the adjacent pixel turned on and the former turned off, in sequence. In this way, there is control over what part of the panel is lit and there is no need to spatially resolve the detection aspect of the imaging. In essence, such implementations involve scanning the illumination to realize the imaging. Such implementations do not require any switches 1015 or diodes 1030. Such implementations may be relatively simpler and cheaper to fabricate. When a front light or another such display light is in operation, an optical touch sensing device 900 of this kind may be capable of scanning a finger swiped across its surface and of making a fingerprint image.

As noted above, a shadow may cause, for portions of photoconductive traces 905 within the shadow, a charge distribution (and consequently a voltage distribution) on the section of photoconductive traces 910 that intersect the shadow to be different from the other sections where the incident light has a higher intensity. The charges from the biased end 1005 to the grounded end 1010 of each photoconductive trace 905 will be distributed across the length of the trace in accordance with the incident light intensity distribution. Here, the control system 920 is capable of causing the array of switches to select one of the photoconductive traces 905 to energize at one time, in sequence (e.g., in consecutive order from top to bottom). The diodes 1030 may be configured to allow a control system to locally probe the voltage distribution across a photoconductive trace 905, via the intersecting metal traces 910. Accordingly, the control system 920 may be capable of determining changes in voltage in portions of the photoconductive traces 905 caused by the changes in charge distribution resulting from changes in intensity of incident light in one or more areas (such as the area 1025) and of determining a location of the area(s). In a similar fashion, the control system 920 may be capable of detecting movements of the one or more areas.

In this example, the control system 920 receives input from an array of differential amplifiers 1020 electrically connected with the metal traces 910. The differential amplifiers 1020 may be capable of amplifying the difference between two voltages. However, in some implementations differential amplifiers 1020 may be capable of amplifying an individual voltage instead. Based on input from the array of differential amplifiers 1020, the control system 920 may be capable of giving a quick and accurate estimate of the location of one or more areas 1025 at any given time. In some implementations, the differential amplifiers may be off-chip CMOS (complementary metal oxide semiconductor) devices, but in other implementations the differential amplifiers may be made of monolithically integrated TFT (thin film transistor) circuitry on the transparent substrate 915.

In this example, the substrate 915 is formed of glass, which may be a borosilicate glass, a soda lime glass, quartz, Pyrex™, or other suitable glass material. In some implementations, if the substrate 915 is formed of glass, the substrate 915 may have a thickness of about 0.3, 0.5 or 0.7 millimeters, although in some implementations the glass substrate can be thicker (such as tens of millimeters) or thinner (such as less than 0.3 millimeters). In some implementations, a non-glass substrate 915 can be used, such as a polycarbonate, acrylic, polyethylene terephthalate (PET) or polyether ether ketone (PEEK) substrate 915. In such an implementation, the non-glass substrate 915 may have a thickness of less than 0.7 millimeters. However, the substrate 915 may be thicker or thinner depending on the design considerations.

In some implementations, the substrate 915 may be adapted for use in a display, e.g., as a cover glass or as a display substrate on which display elements may be formed. Accordingly, in some implementations a display device may include the optical touch sensing device 900. For example, in some implementations a display device such as the display device 40, described below, may include the optical touch sensing device 900. As noted above, the control system 920 may be capable of detecting touch and/or gestures via the optical touch sensing device 900. In some implementations, the control system 920 may be capable of controlling the display device according to touch and/or gestures detected via the optical touch sensing device 900.

FIG. 11 is a schematic diagram that shows examples of elements of the optical touch sensing device of FIG. 9 in a second mode of operation. In the example shown in FIG. 11, the optical touch sensing device 900 is being illuminated with a display light, such as the display light 79 described below with reference to FIG. 19B. In some implementations, the display light may be a front light. In this example, one or more objects (e.g., a finger) in contact with, or adjacent to, one or more areas of the optical touch sensing device 900 will reflect light from the display light 79, causing one or more areas of locally higher-intensity incident light. One example is area 1025 of FIG. 11.

Accordingly, a control system the control system 920 may be capable of determining changes in voltage in portions of the photoconductive traces 905 caused by the changes in charge distribution resulting from changes in intensity of incident light in one or more areas (such as the area 225) and of determining a location of the area(s). In a similar fashion, the control system 920 may be capable of detecting movements of the one or more areas.

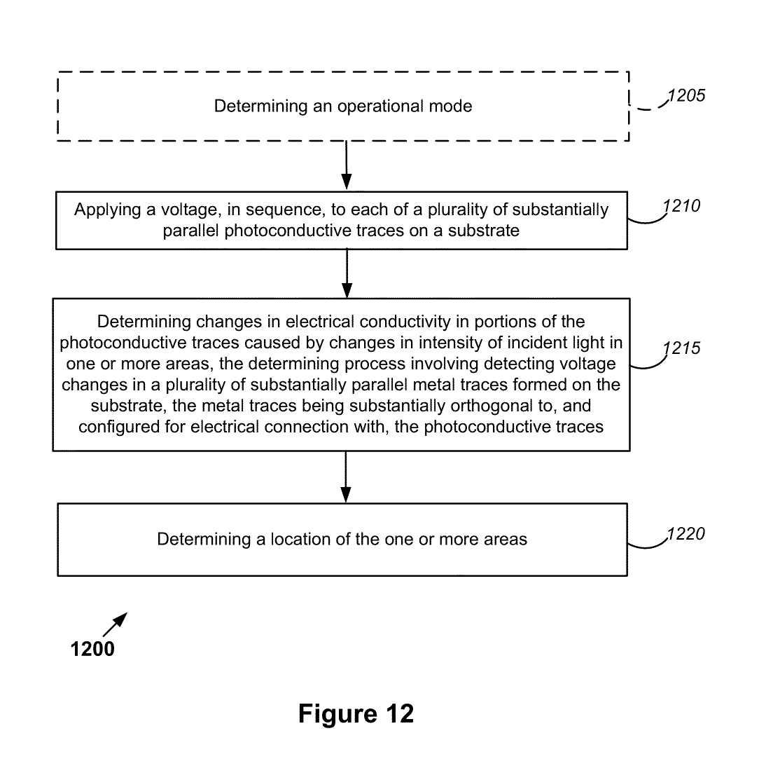

FIG. 12 shows an example of a flow diagram that outlines blocks of an optical touch sensing method. Method 1200 may be performed, at least in part, by one or more elements of a control system, such as the control system 920 shown in FIGS. 9-11. As with other methods described here, the operations of method 1200 are not necessarily performed in the order indicated. Moreover, method 1200 may involve more or fewer blocks than are shown in FIG. 12.

In this example, method 1200 begins with optional block 1205, which involves determining an operational mode. The operational mode may, for example, depend on whether a display light is currently in use. As noted above, the control system may be capable of providing a first operational mode for use under ambient light conditions without a display light in operation and a second operational mode for use when a display light is in operation. One operational mode may involve detecting relatively brighter areas of an optical touch sensing device, whereas another operational mode may involve detecting relatively darker areas of an optical touch sensing device.

In some implementations, the optional block 1205 may involve determining whether a touch sensing operational mode or a gesture recognition operational mode may be used. However, in some implementations a touch sensing operational mode may be substantially the same as a gesture recognition operational mode, at least in terms of determining voltage changes caused by relatively lighter or relatively lighter areas of the optical touch sensing device. Alternatively, or additionally, the optional block 1205 may involve determining whether a fingerprint sensing mode will be used. Some fingerprint sensing examples are described below.

In this example, optional block 1205 involves determining that a touch sensing operational mode will be used. Method 1200 proceeds to block 1210, which involves applying a voltage, in sequence, to each of a plurality of substantially parallel photoconductive traces on a substrate. Block 1210 may, for example, involve applying a voltage, in sequence, to each of the photoconductive traces 905 of an optical touch sensing device 900, as described above with reference to FIG. 10 or FIG. 11.

In this implementation, block 1215 involves determining changes in electrical conductivity in portions of the photoconductive traces caused by changes in intensity of incident light in one or more areas. In this example, the determining process involves detecting voltage changes in a plurality of substantially parallel metal traces formed on the substrate. The metal traces are substantially orthogonal to, and configured for electrical connection with, the photoconductive traces in this example, e.g., as shown in FIGS. 10 and 11.

In this implementation, block 1220 involves determining a location of the one or more areas, such as the area 1025 shown in FIGS. 10 and 11. In some implementations, the substrate may be part of a display device, e.g., a substantially transparent substrate of a display device. In some such implementations, method 1200 may involve controlling the display device according to the location of the one or more areas. Alternatively, or additionally, method 1200 may involve controlling the display device according to movement of the one or more areas.

FIG. 13 shows a top view of examples of elements of an alternative optical touch sensing device. In this example, the photoconductive traces 905 and the metal traces 910 are formed on a display substrate 1300. In some such implementations, the photoconductive traces 905 and the metal traces 910 may be formed between the pixels or subpixels 1305 of a display device that includes the display substrate 1300. In this example, the photoconductive traces 905 and the metal traces 910 have the same pitch as the pixels or subpixels 1305 of the display.

According to some such implementations, the photoconductive traces 905 and/or the metal traces 910 may provide the functionality of a light-masking layer, also referred to herein as a black mask layer. A black mask layer can absorb some or substantially all of the ambient or stray light incident upon a display device. The black mask layer may be used to hide the display metal traces and other inactive display area underneath and therefore inhibiting light from being reflected from these portions of the display, thereby increasing the contrast ratio.

In the example shown in FIG. 13, both the photoconductive traces 905 and the metal traces 910 function as a black mask layer. In this example, the photoconductive traces 905 include a photoconductive material such as amorphous silicon that is formed to substantially absorb the incident light in the visible spectrum and minimize the reflection. For example, mimic antireflective moth eyes, fabricating the photoconductive amorphous silicon in the form of subwavelength-structured pillar arrays can provide substantial absorption and reduce the reflection well below 1%.

In this implementation, to minimize the reflection from the metal traces 910, the metal traces 900 are formed of a black mask structure. The black mask structure can include one or more layers. In this example, at least the portion of the black mask layer in contact with the photoconductive layer is metal and able to form a Schottky barrier. In some implementations, the black mask structure can be an etalon or interferometric stack structure. For example, in some implementations, the interferometric stack black mask structure may include an absorber layer, such as a molybdenum-chromium (MoCr) layer, that serves as an optical absorber, a substantially transparent dielectric layer such as a silicon oxide (SiO₂) layer, and a conductive metal such as platinum (Pt) that serves as a reflector and a busing layer, and is able to form high energy Schottky barrier when in contact with aSi. In some such implementations, the absorber, dielectric layer and conductive metal layers may have thicknesses in the range of about 30-80 Å, 500-1000 Å, and 500-6000 Å, respectively.

In the example shown in FIG. 13, the control system 920 of the optical touch sensing device 900 includes a readout circuit 1310. In this implementation, the readout circuit 1310 is capable of generating the control signals to activate the switches 1015 in proper sequence and is also capable of sensing the analog voltages generated by an energized row as communicated by the metal traces 910. For example, the voltages may be sensed by high input impedance buffer amplifiers, which can be either single-ended or differential inputs. In the latter case, a pair of neighboring conductive metal traces may be used as the plus and minus inputs for a given differential amplifier and neighboring amplifiers may share one metal trace 910 as an input or may have distinct pairs as inputs.

The outputs of the differential amplifiers can then be quantized, either in parallel or through a time-multiplexed sharing of a single or few analog to digital converters. These outputs may then be interpreted on chip to yield the position of an object, e.g., a finger. In the case of high-resolution scanning, the outputs may provide a sensed image output, e.g., of a fingerprint image. The output data can then be provided to the system controller 1315.

In some implementations, the readout circuit 1310 may be realized as a chip on glass (COG) packaging option, in which the chip may make solder bump contacts with metal traces on the glass substrate without wire bonds. The system controller may be another chip which can provide the clock and control data to direct the function of the readout circuit 1310. In highly integrated systems, the system controller itself can be another COG or may even be integrated into the same silicon chip with the readout circuit 1310.

In this example, the area 1330 indicates an intersection of a photoconductive trace 905 and a metal trace 910. In this example, a diode 1030 is formed in the junction of the photoconductive trace 905 and the metal trace 910. For example, the diode 1030 may be a Schottky diode.

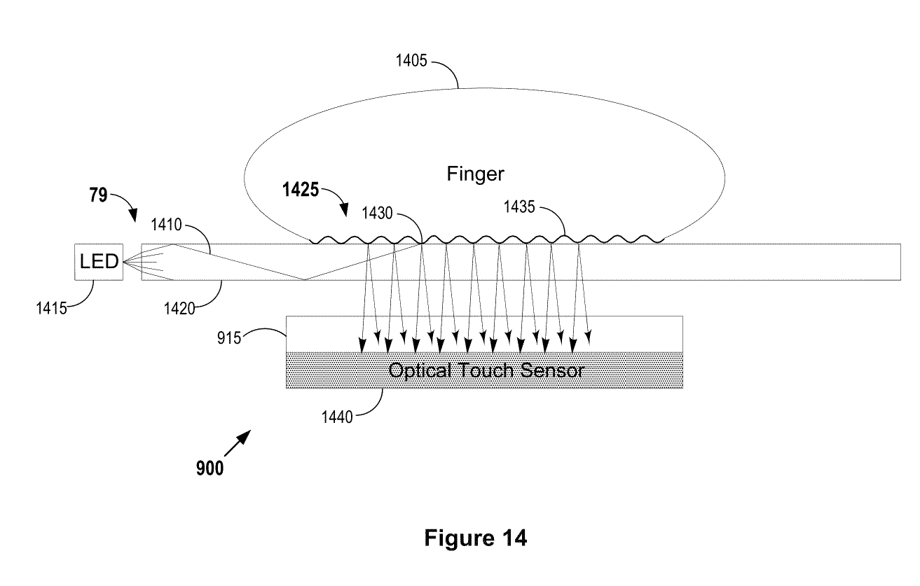

FIG. 14 shows a cross section of examples of elements of an optical touch sensing device in a fingerprint sensing mode of operation. In this example, the optical touch sensing device 900 includes a display front light 79, on which a finger 1405 is placed in this example. The display front light 79 is capable of providing at least some light 1410 to the finger 1405 or to other objects on or near the surface of the display light 79. In this example, the display front light 79 includes a light source 1415 and a light guide 1420. The light guide 1420 may include light-extracting features for providing some light 1410 to the finger 1405 or to other objects. Alternatively, or additionally, the finger 1405 or other objects may be illuminated by light provided by the display light 79 and reflected from a display (not shown).

The finger 1405 includes a fingerprint 1425. As shown in FIG. 14, more light 1410 will generally be reflected from the ridges 1430 than from the depressions 1435 of the fingerprint 1425. Accordingly, light 1410 reflected from the ridges 1430 may pass through the substantially transparent substrate 915 and be detected by the optical touch sensor 1440. The optical touch sensor 1440 may include photoconductive traces 905 and metal traces 910 formed on the substrate 915, as well as other elements of the optical touch sensing device 900 described elsewhere herein. In some implementations, the substrate 915 is a substrate of a display device.

Whether or not the photoconductive traces 905 and the conductive, metal traces 910 are formed on a display substrate, the optical touch sensor 1440 may have a high spatial resolution. In some implementations, the optical touch sensor 1440 may have a spatial resolution that exceeds the minimum threshold resolution to capture fingerprint information. For example, some implementations of the optical touch sensor 1440 may have at least a 500 pixel per inch (ppi) resolution, which meets the requirements for the Federal Bureau of Investigation (FBI) automatic fingerprint identification system. However, some implementations having lower resolution may work well, e.g., for fingerprint matching for identity verification purposes.

As noted above with reference to FIG. 10, some implementations may include only a single photoconductive trace 905. Such implementations do not require any switches 1015 or diodes 1030. When a front light or another such display light is in operation, an optical touch sensing device 900 of this kind may be capable of scanning a finger swiped across its surface and of making a fingerprint image.

In some implementations, an apparatus may include the optical touch sensing device 900 and a display. A control system may be capable of controlling the display to indicate an orientation for a finger to be swept, e.g., across the substantially transparent substrate 915 of FIG. 9. For example, the control system may be capable of controlling the display to depict an arrow, a line, etc., along which the finger should be swept. In some such implementations, the control system may control the display to indicate that the finger should be swept in an orientation that is substantially perpendicular to the axis of the single photoconductive trace 905. In some implementations, additional visual and/or audio prompts may be provided.

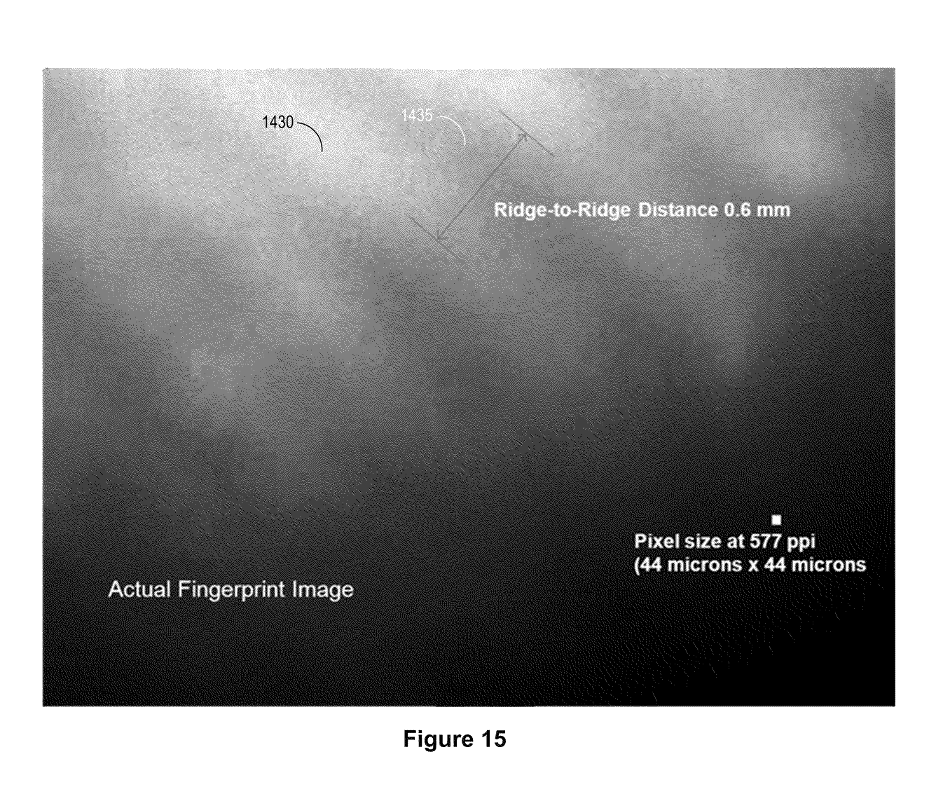

FIG. 15 shows an image of a fingerprint detected by an optical touch sensing device like that of FIG. 14. In this example, FIG. 15 shows an actual image of a fingerprint acquired by an optical touch sensor 1440 having a resolution of 577 ppi, which corresponds to a 44 micron by 44 micron pitch of the photoconductive traces 905 and the metal traces 910. Because more light will generally be reflected from the ridges 1430 than from the depressions 1435 of the fingerprint 1425, the ridges 1430 appear as lighter areas and the depressions 1435 appear as darker areas in FIG. 15.

A device (such as a display device, a computer, etc.) that includes an optical touch sensing device 900 capable of fingerprint sensing also may be capable of biometric control using fingerprint and/or thumb print information. For example, access to the device may be controlled according to authentication of a single print, a predetermined sequence of prints, etc.

However, it may not be necessary for the optical touch sensing device 900 to operate in a fingerprint sensing mode at all times. In general, the resolution required for operating in a touch sensing and/or gesture recognition mode may be substantially less than that required for operating in a fingerprint sensing mode. Accordingly, some implementations of the optical touch sensing device 900 may be capable of a touch sensing and/or gesture recognition mode of operation, wherein only a fraction of the photoconductive traces 905 and the metal traces 910 are being actively used. Such touch sensing and/or gesture recognition modes of operation may use substantially less power and less computational overhead than those required for fingerprint sensor operation.

Therefore, in some implementations an optical touch sensing device 900 may include a control system 920 that is capable of providing a fingerprint sensor operational mode and touch sensor and/or gesture control operational mode. For example, the control system 920 may be capable of operating in a fingerprint sensor operational mode for determining whether to grant access to a room, a building, a device, a data file, etc. In some such implementations, after access has been granted, the control system may be capable of operation in a touch sensing and/or gesture recognition mode.

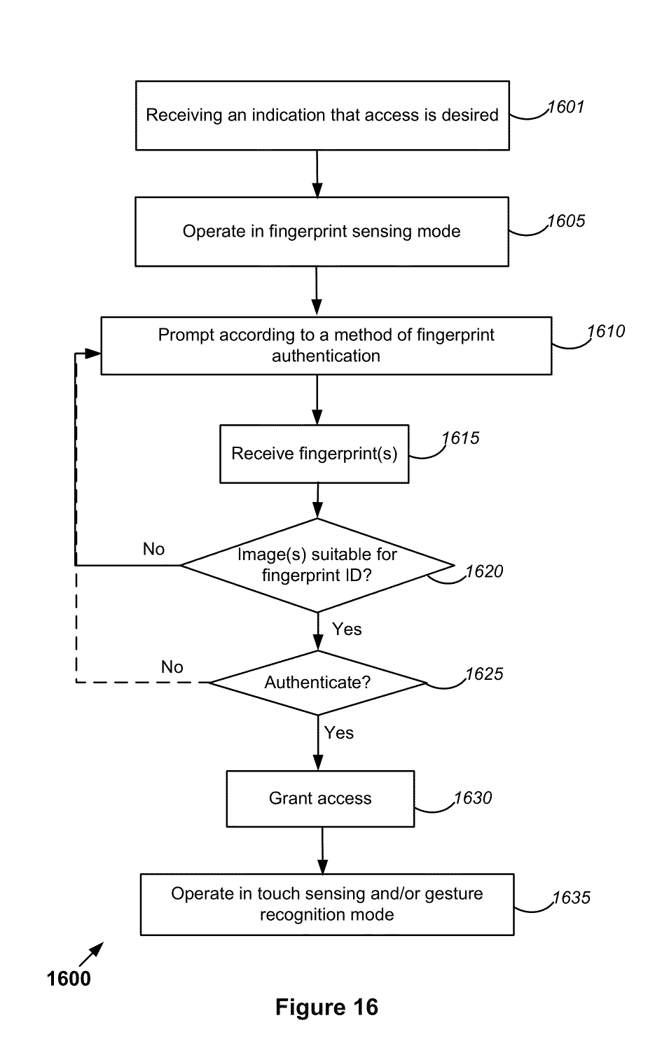

FIG. 16 is a flow diagram that outlines a method of operating an optical touch sensing device. Method 1600 may be performed, at least in part, by one or more elements of a control system of an optical touch sensing device, such as the control system 920 shown in FIGS. 9-11 and 13. As with other methods described here, the operations of method 1600 are not necessarily performed in the order indicated. Moreover, method 1600 may involve more or fewer blocks than are shown in FIG. 16.

In this example, method 1600 begins with block 1601, which involves receiving an indication that access is desired. For example, block 1601 may involve receiving an indication that a display device has been switched on, that user is seeking access to a confidential data file, etc. In this example, block 1605 involves switching an optical touch sensing device to a fingerprint sensing mode of operation.

As noted above, the control system may be capable of authenticating a user according to various methods of fingerprint authentication. Some such methods may involve authenticating a user according to a single fingerprint or thumbprint. (As used herein, the term “fingerprint” will include a thumbprint.) Alternative methods may involve authenticating a user according to the fingerprint of more than one finger or thumb of a user. Some methods may involve authenticating a user according to a predetermined sequence of fingerprints of a user.

Accordingly, in this example block 1615 involves prompting a user to provide one or more fingerprints, according to a method of fingerprint authentication. For example, block 1615 may involve displaying a written prompt on a display, providing an audio prompt via a speaker, etc.

In this implementation, fingerprint images are received in block 1615. In this example, block 1620 involves determining whether the received fingerprint images are of suitable quality for fingerprint-based authentication. If not, the process may revert to block 1615 and the user will be prompted to provide one or more fingerprints according to a method of fingerprint authentication. In some implementations, the same method of fingerprint authentication will be used and the user will be prompted to provide the same fingerprint or the same sequence of fingerprints. However, in alternative implementations, a different method of fingerprint authentication may be used and the user may be prompted to provide a different fingerprint or a different sequence of fingerprints. If no received fingerprint images are of suitable quality for fingerprint-based authentication, the process may end after a predetermined number of prompts.

However, if the received fingerprint images are of suitable quality, the process continues to block 1625, in which it is determined whether to authenticate the user according to a fingerprint-based authentication method. For example, block 1625 may involve the comparison of several features of fingerprint patterns. These features may include patterns, which are aggregate characteristics of ridges, and/or minutia points, which are unique features found within the patterns. Block 1625 may involve comparing the received fingerprint images with fingerprint images in a database. The database may be stored locally or may be accessed remotely.

If the user is authenticated in block 1625, in this example access will be granted in block 1630. In this example, access may be granted to a display device, a computer, etc., that may be controlled, at least in part, according to a touch sensing mode and/or a gesture recognition mode. Accordingly, in block 1635, the optical touch sensing device is configured for operation in a touch sensing mode and/or a gesture recognition mode.

In some implementations, if the user is not authenticated, the user may be given at least one other opportunity for authentication. For example, the process may revert to block 1610. If the user is not authenticated after a predetermined number of attempts, the process may end.

An example of a suitable EMS or MEMS device, to which the described implementations may apply, is a reflective display device. Reflective display devices can incorporate IMODs to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the IMOD. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

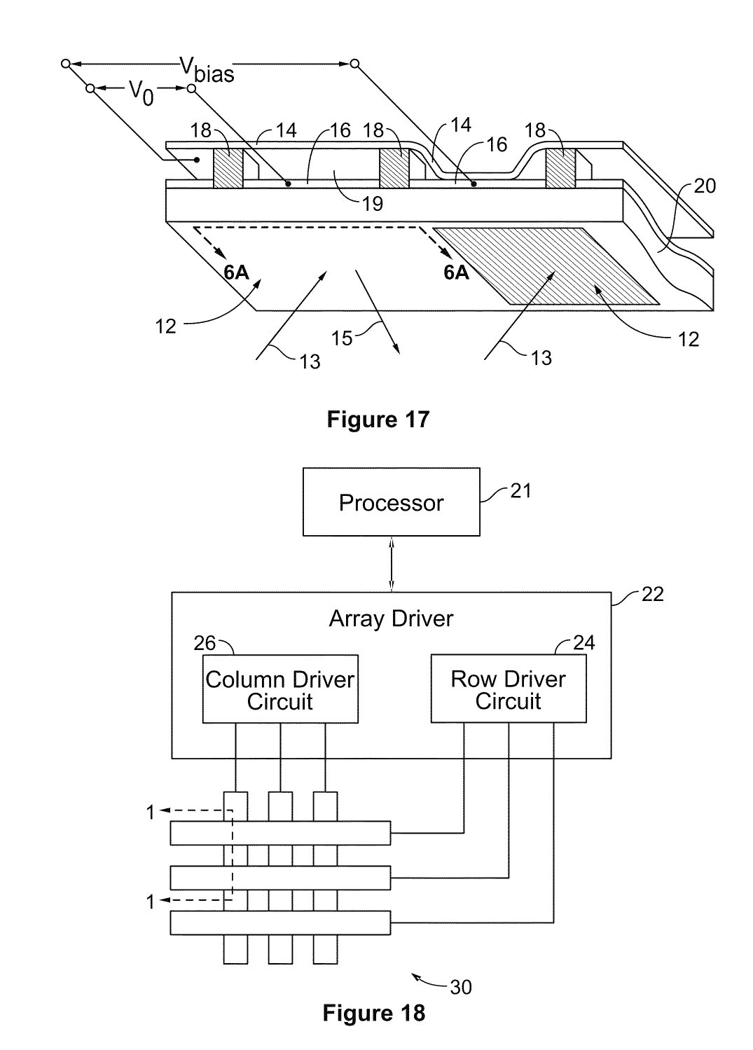

FIG. 17 shows an example of an isometric view depicting two adjacent pixels in a series of pixels of an IMOD display device. The IMOD display device includes one or more interferometric MEMS display elements. In these devices, the pixels of the MEMS display elements can be positioned in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be capable of reflecting predominantly at particular wavelengths allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 17 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 17, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be adapted to be viewed from the opposite side of a substrate as the display elements 12 of FIG. 17 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 17, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 17. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 18 is a system block diagram illustrating an electronic device incorporating an IMOD-based display including a three element by three element array of IMOD display elements. The electronic device includes a processor 21 that may be capable of executing one or more software modules. In addition to executing an operating system, the processor 21 may be capable of executing one or more software applications, including a web browser, a telephone application, an email program, or any other software application.

The processor 21 can be capable of communicating with an array driver 22. The array driver 22 can include a row driver circuit 24 and a column driver circuit 26 that provide signals to, for example a display array or panel 30. The cross section of the IMOD display device illustrated in FIG. 17 is shown by the lines 1-1 in FIG. 18. Although FIG. 18 illustrates a 3×3 array of IMOD display elements for the sake of clarity, the display array 30 may contain a very large number of IMOD display elements, and may have a different number of IMOD display elements in rows than in columns, and vice versa.

FIGS. 19A and 19B show examples of system block diagrams illustrating a display device that includes a touch sensor as described herein. The display device 40 can be, for example, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be capable of conditioning a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 19B, can be capable of functioning as a memory device and be capable of communicating with the processor 21. In some implementations, a power supply 50 can provide power to substantially all components in the particular display device 40 design.

In this example, the display device 40 also includes a touch controller 77. The touch controller 77 may be capable of communicating with the optical touch sensing device 100, e.g., via routing wires, and may be capable of controlling the optical touch sensing device 100. The touch controller 77 may be capable of determining a touch location of a finger, a conductive stylus, etc., proximate the optical touch sensing device 100. The touch controller 77 may be capable of making such determinations based, at least in part, on detected changes in voltage and/or resistance in the vicinity of the touch location. In alternative implementations, however, the processor 21 (or another such device) may be capable of providing some or all of this functionality. Accordingly, a control system 120 as described elsewhere herein may include the touch controller 77, the processor 21 and/or another element of the display device 40.

The touch controller 77 (and/or another element of the control system 120) may be capable of providing input for controlling the display device 40 according to the touch location. In some implementations, the touch controller 77 may be capable of determining movements of the touch location and of providing input for controlling the display device 40 according to the movements. Alternatively, or additionally, the touch controller 77 may be capable of determining locations and/or movements of objects that are proximate the display device 40, e.g., according to one or more areas of relative light or darkness caused by the proximate objects. Accordingly, the touch controller 77 may be capable of detecting finger or stylus movements, hand gestures, etc., even if no contact is made with the display device 40. The touch controller 77 may be capable of providing input for controlling the display device 40 according to such detected movements and/or gestures. As described elsewhere herein, the touch controller 77 (and/or another element of the control system 120) may be capable of providing one or more fingerprint detection operational modes.

In this example, the display device 40 includes a display light 79. In some implementations, the display light 79 may be a front light, a back light, etc. In this example, the display light 79 operates under the control of the processor 21. However, in some implementations, one or more other elements of the control system 120 may be involved in controlling the display light 79. As described elsewhere herein, the control system 120 may be capable of providing a first operational mode for use under ambient light conditions and a second operational mode for use when a display light is in operation.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be capable of allowing, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be capable of functioning as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be capable of receiving power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus. above-described optimization

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that can be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD (or any other device) as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device, comprising:
a display;
an optical touch system proximate the display;
an interface system; and
a control system capable of:
receiving, via the interface system, input for initiating a peer-to-peer data transfer;
performing an authentication process for the peer-to-peer data transfer;
controlling the display device to provide a prompt to position the display device proximate a second device;
controlling the display to display data transfer parameters for the peer-to-peer data transfer;
receiving, via the optical touch system, a confirmation that the second device received the data transfer parameters; and
performing the peer-to-peer data transfer according to the data transfer parameters.

2. The display device of claim 1, further including a memory system, wherein the authentication process involves:
providing a prompt to place at least one finger on a surface of the optical touch system;
receiving, via the optical touch system, at least one fingerprint image;
determining received fingerprint data corresponding to the at least one fingerprint image; and
comparing the received fingerprint data with stored fingerprint data in the memory system.

3. The display device of claim 1, wherein the optical touch system comprises:
a plurality of substantially parallel photoconductive traces formed on a substantially transparent substrate proximate the display; and
a plurality of substantially parallel metal traces formed on the substantially transparent substrate, the metal traces being substantially orthogonal to, and configured for electrical connection with, the photoconductive traces.

4. The display device of claim 3, wherein the optical touch system includes a plurality of Schottky diodes, each Schottky diode of the plurality of diodes being located at an electrical connection between a metal trace and a photoconductive trace.

5. The display device of claim 4, wherein the Schottky diodes include a metal contact at the electrical connection between the metal trace and the photoconductive trace, the metal contact including at least one of palladium, platinum, chromium, tungsten, molybdenum, palladium silicide, platinum silicide or another metal that will induce a Schottky barrier.

6. The display device of claim 5, wherein the photoconductive traces and the metal traces form at least a portion of a light-masking layer on the display substrate.

7. The display device of claim 1, wherein the control system is capable of:
applying a voltage to each of the photoconductive traces, in sequence; and
determining changes in electrical conductivity in portions of the photoconductive traces caused by changes in intensity of incident light.

8. The display device of claim 1, wherein the control system is capable of performing the peer-to-peer data transfer according to a WiFi protocol, according to a Bluetooth™ protocol or via a direct optical link.

9. The display device of claim 1, wherein the photoconductive traces include at least one of amorphous silicon, a conductive polymer, cadmium sulfide, selenium, lead sulfide or quantum dots.

10. A method, comprising:
receiving input for initiating a peer-to-peer data transfer;
performing, via a display device, an authentication process for the peer-to-peer data transfer;
providing a prompt, via the display device, to position the display device proximate a second device;
controlling a display of the display device to display data transfer parameters for the peer-to-peer data transfer;
receiving, via an optical touch system of the display device, a confirmation that the second device received the data transfer parameters; and
performing the peer-to-peer data transfer according to the data transfer parameters.

11. The method of claim 10, wherein the authentication process involves:
providing a prompt to place at least one finger on a surface of the optical touch system;
receiving, via the optical touch system, at least one fingerprint image;
determining received fingerprint data corresponding to the at least one fingerprint image; and
comparing the received fingerprint data with stored fingerprint data.

12. The method of claim 10, wherein the peer-to-peer data transfer is performed according to a WiFi protocol, according to a Bluetooth™ protocol or via a direct optical link.

13. A display device, comprising:
display means;
optical touch means proximate the display means;
interface means; and
control means for:
receiving, via the interface means, input for initiating a peer-to-peer data transfer;
performing an authentication process for the peer-to-peer data transfer;
controlling the display device to provide a prompt to position the display device proximate a second device;
controlling the display means to display data transfer parameters for the peer-to-peer data transfer;
receiving, via the optical touch means, a confirmation that the second device received the data transfer parameters; and
performing the peer-to-peer data transfer according to the data transfer parameters.

14. The display device of claim 13, further including means for storing data, wherein the authentication process involves:
providing a prompt to place at least one finger on a surface of the optical touch means;
receiving, via the optical touch means, at least one fingerprint image;
determining received fingerprint data corresponding to the at least one fingerprint image; and
comparing the received fingerprint data with stored fingerprint data in the means for storing data.

15. The display device of claim 13, wherein the optical touch means comprises:
a plurality of substantially parallel photoconductive traces formed on a substantially transparent substrate proximate the display means; and
a plurality of substantially parallel metal traces formed on the substantially transparent substrate, the metal traces being substantially orthogonal to, and configured for electrical connection with, the photoconductive traces.

16. The display device of claim 15, wherein the optical touch means includes means for forming a Schottky diode at each of a plurality of electrical connections between the metal traces and the photoconductive traces.

17. The display device of claim 16, wherein the means for forming a Schottky diode includes a metal contact at the electrical connection between the metal trace and the photoconductive trace, the metal contact including at least one of palladium, platinum, chromium, tungsten, molybdenum, palladium silicide, platinum silicide or another metal that will induce a Schottky barrier.

18. The display device of claim 15, wherein the photoconductive traces and the metal traces form at least a portion of a light-masking layer on the display substrate.

19. The display device of claim 13, wherein the control means includes means for:
applying a voltage to each of the photoconductive traces, in sequence; and
determining changes in electrical conductivity in portions of the photoconductive traces caused by changes in intensity of incident light.

20. The display device of claim 13, wherein the control means includes means for performing the peer-to-peer data transfer according to a WiFi protocol, according to a Bluetooth™ protocol or via a direct optical link.

21. The display device of claim 13, wherein the photoconductive traces include at least one of amorphous silicon, a conductive polymer, cadmium sulfide, selenium, lead sulfide or quantum dots.

22. A non-transitory medium having software stored thereon, the software including instructions for controlling a display device to:
receive, via an interface system of the display device, input for initiating a peer-to-peer data transfer;
perform an authentication process for the peer-to-peer data transfer;
control the display device to provide a prompt to position the display device proximate a second device;
control a display of the display device to display data transfer parameters for the peer-to-peer data transfer;
receive, via an optical touch system of the display device, a confirmation that the second device received the data transfer parameters; and
perform the peer-to-peer data transfer according to the data transfer parameters.

23. The non-transitory medium of claim 22, wherein the authentication process involves:
providing a prompt to place at least one finger on a surface of the optical touch system;
receiving, via the optical touch system, at least one fingerprint image;
determining received fingerprint data corresponding to the at least one fingerprint image; and
comparing the received fingerprint data with stored fingerprint data in a memory system.

24. The non-transitory medium of claim 22, wherein the peer-to-peer data transfer is performed according to a WiFi protocol, according to a Bluetooth™ protocol or via a direct optical link.
